(19) United States
(12) Patent Application Publication
(10) Pub. No.: US 2023/0287194 A1
(43) Pub. Date: Sep. 14, 2023

(54) POLYMERIZING COMPOSITION, METHOD OF MANUFACTURE THEREOF AND ARTICLES COMPRISING THE SAME

(71) Applicants: The University of Massachusetts, Boston, MA (US); BASF SE, Ludwigshafen am Rhein (DE)

(72) Inventors: Alan James Lesser, Shutesbury, MA (US); Daniel Scott Camarda, Amherst, MA (US); Anna Maria Mueller-Cristadoro, Lemfoerde (DE); Martin Linnenbrink, Lemfoerde (DE); Markus SCHÜTTE, Lemfoerde (DE); John Daguerre-Bradford, West Simsbury, CT (US)

(21) Appl. No.: 18/032,888

(22) PCT Filed: Oct. 20, 2020
(86) PCT No.: PCT/US2021/055797

§ 371 Date: Apr. 20, 2023

Related U.S. Application Data
(60) Provisional application No. 63/093,925, filed on Oct. 20, 2020.

(51) Int. Cl. C08J 9/00

(52) U.S. Cl. CPC C08J 9/0066; C08J 2203/22; C08J 2363/00

(57) ABSTRACT

Disclosed herein is a foam composition comprising a first epoxide comprising a first glycidyl epoxide and/or a first non-glycidyl epoxide; a second epoxide comprising a second glycidyl epoxide and/or a second non-glycidyl epoxide; wherein the first glycidyl epoxide is different from the second glycidyl epoxide and wherein the first non-glycidyl epoxide is different from the second non-glycidyl epoxide; wherein the first and the second epoxide are cationically polymerizable; an initiator; and a diluent; wherein the diluent is present in about 0.1 to 30 wt %, based on the total weight of the composition; wherein the composition upon external stimulus undergoes an ionic polymerization reaction in a spatially propagating reaction front or in a global reaction that occurs throughout an entire composition.

### CROSS REFERENCE TO RELATED APPLICATIONS

This application claims the benefit of U.S. Application No. 63/093,925 filed on Oct. 20, 2020, which is incorporated herein by reference in its entirety.

### BACKGROUND

Disclosed herein is a polymerizing composition, methods of manufacture thereof and articles comprising the same.

Foam materials are a class of commercially and industrially important chemical-based materials. An important aspect of foam manufacturing is the desired ability to self-propagate the polymerization reaction without continuous dependence on an energy source.

Thermal frontal polymerizations typically begin when a heat source contacts a solution of monomer and a thermal initiator. Alternatively, a UV source can be applied if a photoinitiator is also present. The area of contact (or UV exposure) has a faster polymerization rate, and the energy from the exothermic polymerization diffuses into the adjacent region, raising the temperature and increasing the reaction rate at that location. The result is a localized reaction zone that propagates down the reaction vessel as a thermal wave.

There is a continuous demand for foams with desired physical properties manufactured via FP due to their ability to self-propagate through the reaction front.

### SUMMARY

Disclosed herein is a foam composition comprising a first epoxide comprising a first glycidyl epoxide and/or a first non-glycidyl epoxide; a second epoxide comprising a second glycidyl epoxide and/or a second non-glycidyl epoxide; wherein the first glycidyl epoxide is different from the second glycidyl epoxide and wherein the first non-glycidyl epoxide is different from the second non-glycidyl epoxide; wherein the first and the second epoxide are cationically polymerizable; an initiator; and a diluent; wherein the diluent is present in about 0.1 to 30 wt %, based on the total weight of the composition; wherein the composition upon external stimulus undergoes an ionic polymerization reaction in a spatially propagating reaction front or in a global reaction that occurs throughout an entire composition.

Disclosed herein is a method of manufacturing a foam composition comprising mixing together a mixture prepared by a composition comprising a first epoxide comprising a first glycidyl epoxide and/or a first non-glycidyl epoxide; a second epoxide comprising a second glycidyl epoxide and/or a second non-glycidyl epoxide; wherein the first glycidyl epoxide is different from the second glycidyl epoxide and wherein the first non-glycidyl epoxide is different from the second non-glycidyl epoxide; an initiator; and a diluent; wherein the diluent is present in about 0.1 to 30 wt %, based on the total weight of the composition. The method further comprises subjecting the mixture to an external stimulus and facilitating polymerization of the mixture.

Disclosed herein too is a foam composition comprising a free radical polymerizable composition; wherein the free radical polymerizable composition comprises a free radical polymerization initiator and a least one monomer having a functionality greater than 2; and a cationically polymerizable composition comprising a first epoxide comprising a first glycidyl epoxide and/or a first non-glycidyl epoxide; a second epoxide comprising a second glycidyl epoxide and/or a second non-glycidyl epoxide; wherein the first glycidyl epoxide is different from the second glycidyl epoxide and wherein the first non-glycidyl epoxide is different from the second non-glycidyl epoxide; wherein the first and the second epoxide are cationically polymerizable; an initiator; and a diluent; wherein the diluent is present in about 0.1 to 30 wt %, based on the total weight of the composition; and wherein the free radical polymerizable composition is polymerized prior to the cationic polymerization and wherein the composition upon external stimulus undergoes a cationic polymerization reaction in a spatially propagating reaction front or in a global reaction that occurs throughout an entire composition.

Disclosed herein too is a method of manufacturing a foam composition comprising mixing together a mixture comprising a free radical polymerizable composition; wherein the free radical polymerizable composition comprises a free radical polymerization initiator and a least one monomer having a functionality greater than 2; and a cationically polymerizable composition comprising a first epoxide comprising a first glycidyl epoxide and/or a first non-glycidyl epoxide; a second epoxide comprising a second glycidyl epoxide and/or a second non-glycidyl epoxide; wherein the first glycidyl epoxide is different from the second glycidyl epoxide and wherein the first non-glycidyl epoxide is different from the second non-glycidyl epoxide; wherein the first and the second epoxide are cationically polymerizable; an initiator; and a diluent; wherein the diluent is present in about 0.1 to 30 wt %, based on the total weight of the composition; initiating polymerization of the free radical polymerizable composition; and initiating polymerization of the cationically polymerizable composition.

### BRIEF DESCRIPTION OF THE DRAWINGS

FIG. 1 is a depiction of the proposed mechanism for frontal polymerization of an epoxy, showing both thermal and UV initiation;

FIG. 2A is a depiction of the thermal gravimetric analysis of the components in the claimed composition;

FIG. 2B is an expanded view for the thermal gravimetric analysis of the components in the claimed composition;

FIG. 3A is a depiction of the differential scanning calorimetric analysis of the polymerized composition with varying polyol concentration;

FIG. 3B is a depiction of the differential scanning calorimetric analysis of the polymerized composition with varying polyol concentration;

FIG. 4A is a depiction of the dependence of the propagation rate on the polyol concentration;

FIG. 4B depicts the exothermic energy produced by the polymerized composition;

FIG. 5A depicts the density of the polymerized composition with increasing polyol concentration;

FIG. 5B depicts the density of the polymerized composition with increasing rate of polymerization;

FIG. 6 depicts the variation of density in epoxy foams prepared with different surfactants;

FIG. 7 depicts a manufactured foam with its long axis and short axis depicted;

FIG. 8 depicts test tubes that contain foams produced with different amounts of ECC;

FIG. 9 depicts a cross-section of a foam manufactured using 100 wt % ECC;

FIG. 10 depicts cross-sectional images of the frontally polymerized foams prepared from epoxy resins containing different amounts of fumed silica (where T: Top/B: Bottom);

FIG. 11 depicts foam density and porosity for liquid compositions containing 60:40 ECC:DGEBA, 0.5 to 2 wt % of RAZ-P and 0.5 to 1 wt % of DC193;

FIG. 12 details the density and porosity results for foams derived from the UV curing of gels;

FIG. 13 depicts SEM images of 60:40 ECC:DGEBA, 1% RAZ-P, 1% DC 193 liquid formulation samples cryo-fractured parallel (top) and perpendicular (bottom) to the front direction;

FIG. 14 is a bar graph that shows the effect of hollow glass beads (also called iM30K glass bubbles) on density and porosity liquid and gel formulation FP foams; and

FIG. 15 depicts a process for manufacturing a foam from a gel composition.

### DETAILED DESCRIPTION

Disclosed herein is a composition for producing a foam via an ionically frontal polymerizing system that contains two or more reactive species in a reaction mixture. The composition comprises two or more reactive species and an initiator blend that comprises two or more initiators. In an embodiment, the reaction mixture comprises a diluent. In an exemplary embodiment, the respective reactants are polymerized by applying an external stimulus to the composition. The composition upon polymerizing forms a foam by virtue of the fact that a portion of the reactants evaporates and/or decomposes during the frontal polymerization. The evaporating reactants phase separate from the composition resulting in the formation of a foam as the composition undergoes crosslinking. In an embodiment, the amount of the diluent in the reaction mixture can be varied to obtain a desired density for the composition. The unreacted reaction mixture can be stored for up to a week, more preferably up to 1 month, and most preferably up to 1 to 2 years. In a preferred embodiment, the unreacted reaction mixture can be activated on demand.

The composition for producing the foam may be in the form of a liquid or in the form of a gel. A liquid composition preferably does not comprise a monomer that can undergo polymerization via free radical polymerization. The composition may also be devoid of a free radical initiator. The liquid composition contains only ionically polymerizable initiators and monomers.

The composition for producing gels (which are then frontally polymerized to form foams) comprises a combination of free radically polymerizable monomers and initiators in addition to the ionically polymerizable monomers and initiators. The free radically polymerizable monomers are preferably polymerized prior to the ionically polymerizable monomers thus producing the gel. The ionically polymerizable monomers are subsequently polymerized to produce the foam.

Disclosed herein too is a method for manufacturing foamed articles from a composition for a frontally polymerizing system that contains two or more reactive species. The method involves mixing the two or more reactive species with an initiator that comprises two or more initiators and reacting the respective reactants using an external stimulus. In an exemplary embodiment, the composition is cured using electromagnetic radiation, examples of which are ultraviolet radiation, microwave radiation, infrared radiation, or a combination thereof. The ability to cure the composition without having to submit the entire part assembly to a large oven, thermal blanket, or radiant heater is advantageous for flexible and efficient manufacturing of articles. In an embodiment, the composition can be poured into a mold and will form a foam during curing. The foam will take the shape of the mold.

Disclosed herein too is a method of manufacturing a foam from a gel composition. As noted above, the gel composition is produced by first polymerizing a free radical polymerizable monomer in the composition. The polymerization of the free radical polymerizable monomer produces a gelled framework that retains the ionically polymerizable monomers in place. The ionically polymerizable monomers are then polymerized to form the foam (via frontal polymerization).

The composition is advantageous in that it is shelf stable—i.e., it can be stored for long periods of time (e.g., at room temperature or below in the preferred absence of UV radiation) such as, for example, up to 1 week, more preferably up to 1 month, and most preferably greater than an year, without appreciable changes in the composition. The shelf life is determined for a composition that is stored at a temperature of about 25° C. or lower, preferably at about 0° C. or lower, and more preferably at about −20° C. or lower. When desired the composition is poured into a mold or a preform and upon undergoing polymerization it forms a foam in the mold or in the preform. The foam takes the shape of the preform. The composition can be advantageously used in devices where it is desirable to form a foam in parts that cannot be easily accessed. The foams can be used for vibration damping, sound damping, moisture absorption, and the like. They can also be used to form thermally insulating material.

In an embodiment, the composition comprises a reaction mixture having two or more reactive species that can undergo polymerization reactions upon being subjected to an external stimulus. The composition is stable at room temperature when protected from UV radiation.

In an embodiment, the composition for the frontally polymerizing system comprises two or more different monomers comprising epoxides—a first epoxide and a second epoxide. In a preferred embodiment, the epoxide monomers have more than one epoxide group. The epoxide monomers are such that they can undergo ionic polymerization. Ionic polymerization may include cationic and/or anionic polymerization. In an embodiment, the monomers include epoxies (oxirane), thiiranes (episulfides), oxetanes, lactams, lactones, lactides, glycolides, tetrahydrofuran, or a mixture thereof. In a preferred embodiment, the monomers include aliphatic epoxides formed by the epoxidation of double bonds. The aliphatic epoxides can be cycloaliphatic epoxides. In a preferred embodiment, the monomers include aromatic epoxides formed by the epoxidation of phenols. The epoxide monomers can include functional groups, including, but not limited to the ethers, enol ethers, esters, and alcohols. In an embodiment, the epoxide monomers can be halogenated.

In an embodiment, the first epoxide and the second epoxide comprises a first glycidyl epoxide and/or a first non-glycidyl epoxide, while the second epoxide comprises a second glycidyl epoxide and/or a second non-glycidyl epoxide. In an embodiment, the first glycidyl epoxide is not the same as the second glycidyl epoxide when both glycidyl epoxides are used in the composition. In an embodiment, the first non-glycidyl epoxide may be the same as or different from the second non-glycidyl epoxide when both are used in the composition.

In an embodiment, it is desirable for the composition to contain a first epoxide that is a glycidyl epoxide and a second epoxide that is a non-glycidyl epoxide. In another embodiment, it is desirable for the composition to contain a first epoxide that is a glycidyl epoxide (a first glycidyl epoxide) and a second epoxide (a second glycidyl epoxide) that is also a glycidyl epoxide, where the first glycidyl epoxide is different from the second glycidyl epoxide.

In an embodiment, the first epoxide comprises a first glycidyl epoxide while the second epoxide comprises a second glycidyl epoxide and/or a non-glycidyl epoxide, where the first glycidyl epoxide is different from the second glycidyl epoxide. The terms “different” and “not the same as” implies that the two glycidyl epoxides or non-glycidyl epoxides are chemically different from one another, i.e., they have at least one atomic or molecular moiety that differs from the first glycidyl epoxide when compared with the second glycidyl epoxide.

The first epoxide and second epoxide may be monomers, dimers, trimers, quadramers, pentamers, and the like, all the way to oligomers and are preferably miscible with each other at reaction conditions. While it is desirable for the epoxide monomers to be compatible with each other, it is also possible to use epoxides that are semi-compatible or even incompatible with each other. Surfactants, block copolymers, and other compatibilizers may be added to the composition to bring about partial or complete miscibility between the first epoxide and the second epoxide.

The first epoxide monomers and the second epoxide monomers in the claimed composition are those that can be polymerized by ionic polymerization. In an embodiment, the first epoxide monomers and the second epoxide monomers may include aromatic, aliphatic or cycloaliphatic epoxy compounds. In an embodiment, the first epoxide monomer and the second epoxide monomer separately has at least one, preferably at least two, epoxy groups in each epoxide molecule.

In an embodiment, the first epoxide and the second epoxide monomers are glycidyl ethers and β-methylglycidyl ethers of aliphatic or cycloaliphatic diols or polyols, e.g., those of ethylene glycol, propane-1,2-diol, propane-1,3-diol, butane-1,4-diol, diethylene glycol, polyethylene glycol, polypropylene glycol, glycerol, trimethylolpropane or 1,4-dimethylolcyclohexane, or of 2,2-bis(4-hydroxycyclohexyl) propane and N,N-bis(2-hydroxyethyl)aniline; the glycidyl ethers of di- and polyphenols, typically of resorcinol, for example, resorcinol diglycidyl ether, glycidyl ethers of 4,4′-dihydroxyphenyl-2,2-propane, of novolaks or of 1,1,2,2-tetrakis(4-hydroxyphenyl)ethane. Illustrative examples are phenyl glycidyl ether, p-tert-butyl glycidyl ether, o-icresyl glycidyl ether, polytetrahydrofuran glycidyl ether, n-butyl glycidyl ether, 2-ethylhexyl glycidyl ether, C₁₂₋₁₅ alkyl glycidyl ether, cyclohexanedimethanol diglycidyl ether. Other examples are N-glycidyl compounds, typically the glycidyl compounds of ethylene urea, 1,3-propylene urea or 5-dimethylhydantoin or of 4,4′-methylene-5,5′-tetramethyidi-hydantoin, or e.g., triglycidyl isocyanurate.

In an embodiment, the first epoxide monomer and the second epoxide monomer is aliphatic in nature, for example, a cycloaliphatic glycidyl ether, also known as EPON 1510.

In yet another embodiment, the first epoxide monomers and the second epoxide monomers may be the glycidyl esters of carboxylic acid, preferably di- and polycarboxylic acids. Typical examples are the glycidyl esters of succinic acid, adipic acid, azelaic acid, sebacic acid, phthalic acid, terephthalic acid, tetra- and hexa-hydrophthalic acid, isophthalic acid, trimellitic acid, or of dimerized fatty acids, or the like, or a combination thereof.

Additional exemplary first epoxide monomers and second epoxide monomers include epoxy, glycidyl ether and epoxycyclohexyl functional siloxanes and siloxane derivatives such as epoxypropoxypropyl terminated polydimethylsiloxanes and 1,3-bis[2-(3,4-epoxycyclohexyl) ethyl] tetramethyldisiloxane.

Examples of suitable first epoxide monomers and second epoxide monomers are diglycidyl ether of bisphenol A, diomethane diglycidyl ether, 2,2-bis(4-glycidyloxyphenyl)propane, 2,2′-((1-methylethylidene)bis(4,1-phenyleneoxymethylene))bisoxirane, 2,2-bis(4-(2,3-epoxypropyloxy)phenyl)propane, 2,2-bis(4-hydroxyphenyl)propane, diglycidyl ether, 2,2-bis(p-glycidyloxyphenyl)propane, 4,4′-bis(2,3-epoxypropoxy)diphenyldimethylmethane, 4,4′-dihydroxydiphenyldimethylmethane diglycidyl ether, 4,4′-isopropylidenebis(1-(2,3-epoxypropoxy)benzene), 4,4′-isopropylidenediphenol diglycidyl ether, bis(4-glycidyloxyphenyl)dimethylmethane, bis(4-hydroxyphenyl)dimethylmethane diglycidyl ether, diglycidyl ether of bisphenol F, 2-(butoxymethyl)oxirane, the reaction product of 2-(chloromethyl)oxirane and 4-[2-(4-hydroxyphenyl)propan-2-yl]phenol also known as bisphenol A-epichlorohydrin based epoxy, modified bisphenol A epichlorohydrin based epoxy, diglycidyl 1,2-cyclohexanedicarboxylate, 1,4-cyclohexanedimethanol diglycidyl ether, a mixture of cis and trans 1,4-cyclohexanedimethanol diglycidyl ether, neopentyl glycol diglycidyl ether, resorcinol diglycidyl ether, 4,4′-methylenebis(N,N-diglycidylaniline), 3,4-epoxycyclohexylmethyl 3,4-epoxycyclohexanecarboxylate, 3,4-epoxy-1-cyclohexanecarboxylic acid, 3,4-epoxycyclohexan-1-yl)methyl ester, tert-butyl glycidyl ether, 2-ethylhexyl glycidyl ether, epoxypropoxypropyl terminated polydimethylsiloxanes, neopentyl glycol diglycidyl ether, 1,4-cyclohexanedimethanol diglycidyl ether, 1,3-bis[2-(3,4-epoxycyclohexyl)ethyl]tetramethyldisiloxane, trimethylolpropane triglycidyl ether, diglycidyl 1,2-cyclohexanedicarboxylate, or the like, or a combination thereof.

In a preferred embodiment, the first epoxide monomer and the second epoxide monomer are (different from each other) but are glycidyl epoxides comprising a cycloaliphatic epoxy compound. The different glycidyl monomers are shown below. In an embodiment, a useful glycidyl epoxide is a diglycidyl ether of bisphenol F, also known as Epon 862° and having the structure shown in the chemical formula (I)

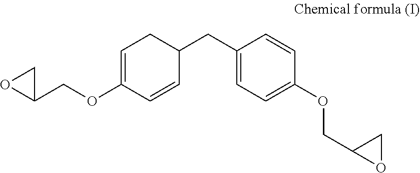

In another embodiment, the glycidyl epoxide is a modified diglycidyl ether of bisphenol F also known as a modified EPON 862® and having the structure shown in the chemical formula (II) below:

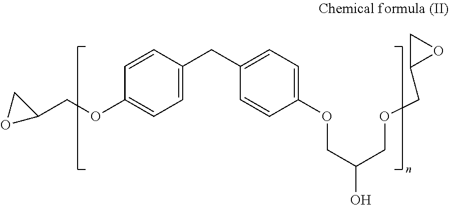

In the above chemical formula (II) n is the number of repeat units and can be an integer from 2 to 1000, preferably 3 to 500, and more preferably 4 to 200. The epoxy resin of the chemical formula (II) is produced by polymerizing bisphenol F with the EPON 862.

In yet another embodiment, the glycidyl epoxide may have the structure shown in the chemical formula (III) below:

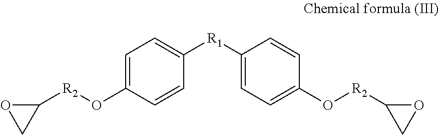

In the above chemical formula (III), R₁ is a single bond, —O—, —S—, —C(O)—, or a C₁₋₁₈ organic group. The C₁₋₁₈ organic bridging group may be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In the Formula (III), R₂ is a C₁₋₃₀ alkyl group, a C₃₋₃₀ cycloalkyl, a C₆₋₃₀ aryl, a C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl, a C₂₋₁₀ fluoroalkyl group, or a combination thereof.

Other exemplary variations of the chemical formula (II) that may be used are shown in the chemical formulas (IV) and (V). In an embodiment, one variation of the chemical formula (III) that may be used is shown in the chemical formula (IV) below.

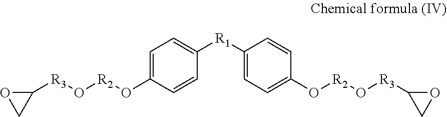

In the above chemical formula (IV), R₁ is detailed above in chemical formula (III), R₂ and R₃ may be the same or different and are independently a C₁₋₃₀ alkyl group, a C₃₋₃₀ cycloalkyl, a C₆₋₃₀ aryl, a C₇₋₃₀ alkaryl, a C₇₋₃₀ aralkyl, a C₁₋₃₀ heteroalkyl, a C₃₋₃₀ heterocycloalkyl, a C₆₋₃₀ heteroaryl, a C₇₋₃₀ heteroalkaryl, a C₇₋₃₀ heteroaralkyl, a C₂₋₁₀ fluoroalkyl group, or a combination thereof.

In an exemplary embodiment, a glycidyl epoxide having the structure of chemical formula (V) may be used in the composition.

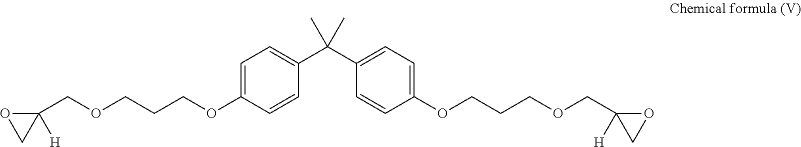 [SMILES: CC(C)(c1ccc(OCCCOCC2CO2)cc1)c1ccc(OCCCOCC2CO2)cc1]

In a preferred embodiment, the glycidyl epoxide is the reaction product of 2-(chloromethyl) oxirane and 4-[2-(4-hydroxyphenyl) propan-2-yl] phenol also known as bisphenol A-epichlorohydrin based epoxy (also known as bisphenol A diglycidyl ether) of the chemical formula (VI) below:

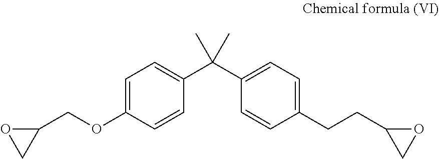 [SMILES: CC(C)(c1ccc(CCC2CO2)cc1)c1ccc(OCC2CO2)cc1]

The glycidyl epoxide of the chemical formula (VI) is commercially available as EPON 828. A polymeric version of the epoxy resin of the chemical formula (VI) is shown in chemical formula (VI A) and may also be used.

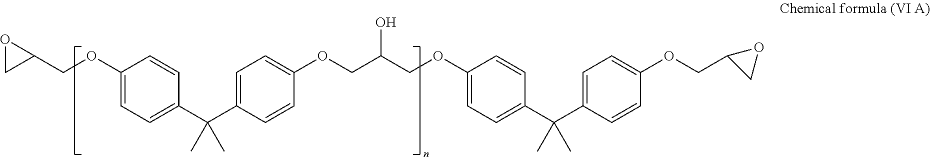

In the above chemical formula (VI A), n can be an integer of 2 to 1000, preferably 3 to 500, and more preferably 4 to 200.

When two different glycidyl monomers are used (as the first glycidyl monomer and the second glycidyl monomer, which are different from each other), the first glycidyl monomer is used in an amount of 1 wt % to 40 wt %, more preferably in an amount of 10 wt % to 30 wt %, and most preferably in an amount of 15 wt % to 25 wt %, based on the total weight of the composition, while the second glycidyl monomer is used in an amount of 1 wt % to 40 wt %, more preferably in an amount of 10 wt % to 30 wt %, and most preferably in an amount of 15 wt % to 25 wt %, based on the total weight of the composition.

In an embodiment, the total amount of the glycidyl epoxide is present in an amount of 1 wt % to 60 wt %, more preferably in an amount of 20 wt % to 50 wt %, and most preferably in an amount of 25 wt % to 40 wt %, based on the total weight of the composition.

The first and the second epoxide monomers can also be non-glycidyl epoxides. The first non-glycidyl epoxide and the second non-glycidyl epoxide monomers are different from each other and can also be polymerized by ionic polymerization. In an embodiment, the first and the second non-glycidyl epoxides are cycloaliphatic epoxides containing oxirane rings attached to their cyclic structures. In an embodiment, the cycloaliphatic epoxides can have functional groups like alkyl, alkenyl, vinyl, alkoxy, phenyl, or benzyl groups.

In a preferred embodiment, the cycloaliphatic epoxide used in the composition is not specifically limited as long as it contains two or more epoxy groups per molecule. The epoxy groups preferably each contain two carbon atoms constituting the alicyclic skeleton.

Examples of suitable epoxide monomers that can be used as the second epoxide monomer are represented by the chemical formulas VII (a) to VII (g)

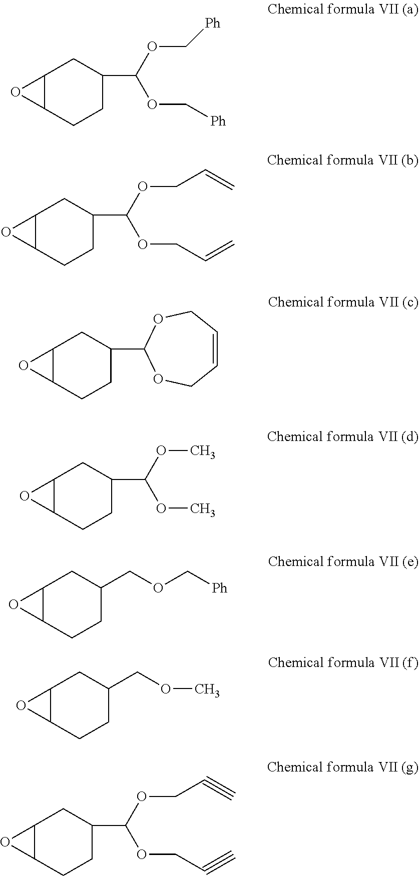

In an embodiment, the first and/or second non-glycidyl epoxide is a monomer represented by Chemical formula (VIII):

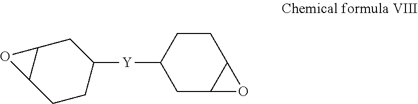

In Formula (X), Y represents a linkage group. Examples of Y are single bond, a divalent hydrocarbon group, carbonyl group (—CO—), ether bond (—O—), ester bond (—COO—), amide bond (—CONH—), carbonate bond (—OCOO—), and a group comprising two or more of these groups combined with each other. Preferred examples of the divalent hydrocarbon group are linear or branched alkylene groups and divalent alicyclic hydrocarbon groups typified by cycloalkylene groups, each of which has eighteen or less carbon atoms. The linear or branched alkylene groups include methylene, methylmethylene, dimethylmethylene, ethylene, propylene, and trimethylene groups. The divalent alicyclic hydrocarbon groups include 1,2-cyclopentylene, 1,3-cyclopentylene, cyclopentylidene, 1,2-cyclohexylene, 1,3-cyclohexylene, 1,4-cyclohexylene, and cyclohexylidene group.

In an embodiment, the first and second non-glycidyl epoxide monomer has two or more epoxide groups. Examples of suitable epoxides that can be used are bis(2,3-epoxycyclopentyl) ether, 1,2-bis (2,3-epoxycyclopentyloxy)ethane, 3,4-epoxycyclohexyl-methyl 3,4-epoxycyclohexanecarboxylate, 3,4-epoxy-6-methyl-cyclohexylmethyl 3,4-epoxy-6-methylcyclohexanecarboxylate, di(3,4-epoxycyclohexylmethyl)hexanedioate, di(3,4-epoxy-6-methylcyclohexylmethyl) hexanedioate, ethylenebis (3,4-epoxy cyclohexanecarboxylate, ethanediol di(3,4-epoxycyclohexylmethyl)ether, vinylcyclohexene dioxide, dicyclopentadiene diepoxide or 2-(3,4-epoxycyclohexyl-5,5-spiro-3,4-epoxy)cyclohexane-1,3-dioxane, 2,2′-bis-(3,4-epoxy-cyclohexyl)-propane or the like, or a combination thereof.

In yet another exemplary embodiment, the non-glycidyl epoxide is a monomer represented by the following compounds having chemical formulas IX (a) to IX (g), wherein the number of repeat units n denotes an integer of 1 to 30.

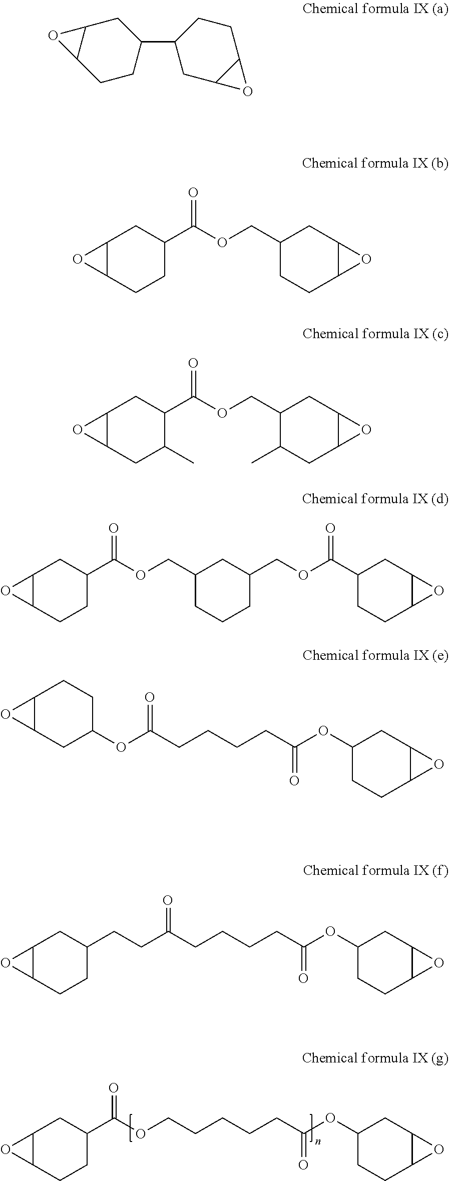

In a preferred embodiment, the non-glycidyl epoxide is 3,4-epoxy cyclohexylmethyl-3′,4′-epoxy cyclohexane carboxylate represented by the chemical formula (XII) below:

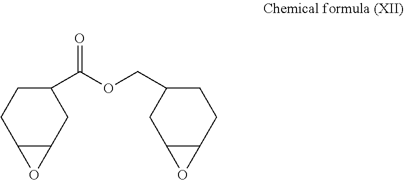 [SMILES: O=C(OCC1CCC2OC2C1)C1CCC2OC2C1]

When two different non-glycidyl epoxide monomers are used (as the first non-glycidyl epoxide monomer and the second non-glycidyl epoxide monomer, which are different from each other), the first non-glycidyl epoxide monomer is used in an amount of 20 wt % to 40 wt %, more preferably in an amount of 25 wt % to 35 wt %, and most preferably in an amount of 28 wt % to 33 wt %, based on the total weight of the composition, while the second non-glycidyl epoxide monomer is used in an amount of 20 wt % to 40 wt %, more preferably in an amount of 25 wt % to 35 wt %, and most preferably in an amount of 28 wt % to 33 wt %, based on the total weight of the composition.

In a yet another embodiment, the first and the second epoxide are both non-glycidyl epoxides. In an embodiment, the non-glycidyl epoxide is present in an amount of 100 wt %, based on the total weight of the composition.

In an embodiment, the first non-glycidyl epoxide and/or the second non-glycidyl epoxide are present in a combined amount of 40 wt % to 75 wt %, more preferably in an amount of 50 wt % to 65 wt %, and most preferably in an amount of 55 wt % to 60 wt %, based on the total weight of the composition.

In a preferred embodiment, the first epoxide comprises a first glycidyl epoxide and the second epoxide comprises a second glycidyl epoxide and/or a non-glycidyl epoxide, where the first glycidyl epoxide is different than the second glycidyl epoxide.

The composition further contains an initiator blend that contains two or more initiators namely a first initiator that comprises at least one free radical initiator and a second initiator that comprises at least one cationic initiator. The initiator blend may further contain at least one ionic accelerator. In an embodiment, the at least one ionic accelerator is a cationic accelerator or an anionic accelerator.

In a preferred embodiment, the initiators may be present in the form of an initiator blend comprising an initiator and a co-initiator. The initiators may be photoinitiators, thermal initiators, or a combination thereof. In some embodiments, photoinitiators can be thermal initiators or vice-versa depending upon the initiation or polymerization temperature of the low molecular weight molecules. A thermal radical generator may be added if desired. The thermal radical generator dissociates under heat to produce radicals that aid in the oxidation of the ionic initiator.

In a preferred embodiment, the at least one ionic accelerator is a cationic accelerator. The cationic accelerator may be a thermal radical generator that can facilitate frontal polymerization.

In general, a radical initiator generates radicals upon activation that promote polymerization of the monomers. In the case of photoinitiators, the activation energy is derived primarily from electromagnetic radiation (e.g., ultraviolet light, visible light, x-rays, electrons, protons, or a combination thereof) while in the case of thermal initiators, the activation energy is derived from heat (e.g., conduction or convection) or electromagnetic radiation that involves the generation of heat (e.g., infrared radiation, microwave radiation, or a combination thereof). Induction heating may also be used.

In a preferred embodiment, a suitable cationic initiator may be used. Exemplary cationic initiators are onium salts containing a SbF₆, PF₆, BF₄, AlO₄C₁₂F₃₆ or a C₂₄BF₂₀ anion. Examples of suitable cationic initiators for reacting the epoxy resins are bis(4-hexylphenyl)iodonium hexafluoroantimonate, bis(4-hexylphenyl)iodonium hexafluorophosphate, (4-hexylphenyl)phenyliodonium hexafluoroantimonate, (4-hexylphenyl)phenyliodonium hexafluorophosphate, bis(4-octylphenyl)iodonium hexafluoroantimonate, [4-(2-hydroxytetradecyloxy)phenyl] phenyl iodonium hexafluoroantimonate, [4-(2-hydroxydodecyloxy)phenyllphenyliodonium hexafluoroantimonate, bis(4-octylphenyl)iodonium hexafluorophosphate, (4-octylphenyl)phenyliodonium hexafluoroantimonate, (4-octylphenyl)phenyliodonium hexafluorophosphate, bis(4-decylphenyl)iodonium hexafluoroantimonate, bis(4-decylphenyl)iodonium hexafluorophosphate, (4-decylphenyl)phenyliodonium hexafluoroantimonate, (4-decylphenyl)phenyliodonium hexafluorophosphate, (4-octyloxyphenyl)phenyliodonium hexafluoroantimonate, (4-octyloxyphenyl)phenyliodonium hexafluorophosphate, (2-hydroxydodecyloxyphenyl)phenyliodonium hexafluoroantimonate, (2-hydroxydodecyloxyphenyl)phenyliodonium hexafluorophosphate, bis(4-hexylphenyl)iodonium tetrafluoroborate, (4-hexylphenyl)phenyliodonium tetrafluoroborate, bis(4-octylphenyl)iodonium tetrafluoroborate, (4-octylphenyl)phenyliodonium tetrafluoroborate, bis(4-decylphenyl)iodonium tetrafluoroborate, bis(4-(mixed C₈-C₄alkyl)phenyliodonium hexafluoroantimonate, (4-decylphenyl)phenyliodonium tetrafluoroborate, (4-octyloxyphenyl)phenyliodonium tetrafluoroborate, (2-hydroxydodecyloxyphenyl)phenyliodonium tetrafluoroborate, biphenylene iodonium tetrafluoroborate, biphenylene iodonium hexafluorophosphate, biphenylene iodonium hexafluoroantimonate, bis(4-tert-butylphenyl)iodonium perfluoro-1-butanesulfonate electronic grade, bis(4-tert-butylphenyl)iodonium p-toluenesulfonate electronic grade, (p-isopropylphenyl)(p-methylphenyl)iodonium tetrakis(pentafluorophenyl) borate, bis(4-tert-butylphenyl)iodonium triflate electronic grade, boc-methoxyphenyldiphenylsulfonium triflate, (4-tert-butylphenyl)diphenylsulfonium triflate, diphenyliodonium hexafluorophosphate, diphenyliodonium nitrate, diphenyliodonium perfluoro-1-butanesulfonate electronic grade, diphenyliodonium p-toluenesulfonate, diphenyliodonium triflate electronic grade, (4-fluorophenyl)diphenylsulfonium triflate, N-hydroxy-5-norbornene-2,3-dicarboximide perfluoro-1-butanesulfonate, (4-iodophenyl)diphenylsulfonium triflate, (4-methoxyphenyl)diphenylsulfonium triflate, 2-(4-methoxystyryl)-4,6-bis(trichloromethyl)-1,3,5-triazine, (4-methylphenyl)diphenylsulfonium triflate, (4-methylthiophenyl)methyl phenyl sulfonium triflate, 1-naphthyl diphenylsulfonium triflate, (4-phenoxyphenyl)diphenylsulfonium triflate, (4-phenylthiophenyl)diphenylsulfonium triflate, triarylsulfonium hexafluoroantimonate salts, triarylsulfonium hexafluorophosphate, triphenylsulfonium perfluoro-1-butanesufonate, diphenyliodonium tetrakis(perfluoro-t-butyloxy)aluminate or the like, or a combination thereof. An exemplary cationic initiator is p-(octyloxyphenyl)phenyliodonium hexafluoroantimonate.

In another embodiment, a coinitiator comprising organic and inorganic compounds can be used. In accordance with the embodiments of the present invention the coinitiator used in the compositions is not specifically limited as long as it can undergo homolytic fission to generate free radicals.

In an embodiment, coinitiators include azo compounds, inorganic peroxides, organic peroxides, or the likes, or combinations thereof. In an embodiment, more than one coinitiator can be used.

Examples of suitable coinitiators for reacting the epoxy resins are tert-butyl hydroperoxide, tert-butyl peracetate, cumene hydroperoxide, 2,5-di(tert-butylperoxy)-2,5-dimethyl-3-hexyne, dicumyl peroxide, 2,5-bis(tert-butylperoxy)-2,5-dimethylhexane, 2,4-pentanedione peroxide, 4-hydroxy-4-methyl-2-pentanone, N-methyl-2-pyrrolidone, 1,1-bis(tert-butylperoxy)-3,3,5-trimethylcyclohexane, 1,1-bis(tert-butylperoxy)cyclohexane, 1,1-bis(tert-amylperoxy)cyclohexane, butanone peroxide, tert-butyl peroxide, lauroyl peroxide, tert-butyl peroxybenzoate, tert-butylperoxy 2-ethylhexyl carbonate, tert-butyl hydroperoxide,

4,4′-azobis(4-cyanovaleric acid, 1,1′-azobis(cyclohexanecarbonitrile), azobisisobutyronitrile, 2,2′-azobis(2-methylpropionamidine) dihydrochloride, 2,2′-azobis(2-methylpropionitrile), 2,2′-azobis(2-methylpropionitrile) recrystallized from methanol, ammonium persulfate, hydroxymethanesulfinic acid monosodium salt dihydrate, potassium persulfate, sodium persulfate or the like, or a combination thereof. In an embodiment, the coinitiator is 1,1,2,2-tetraphenyl-1,2-ethanediol.

In a preferred embodiment, the initiator used are individually present in an amount of 0.5 to 5 wt %, preferably 1 to 3 wt % and more preferably 1.5 to 2.5 wt %, based on the total weight of the composition.

In an embodiment, the composition for the frontally polymerizing system may comprise fillers. In the claimed composition, the objective of the filler is to vary or determine the chemical, physical and mechanical properties of the composition. The fillers are used to adjust the viscosity of the composition.

The filler can be particulate like or fibrous in its geometry. Both articulate and fibrous fillers may be organic or inorganic fillers. Particulate fillers have a radius of gyration of 2 nanometers to 10 micrometers, preferably 10 nanometers to 5 micrometers, and more preferably 20 nanometers to 1 micrometer. Fibrous fillers can have a diameter of 2 nanometers to 10 micrometers and preferably 10 nanometers to 5 micrometers. Fibrous fillers preferably have aspect ratios (length to diameter) of greater than 5, preferably greater than 10 and more preferably greater than 100.

Examples of fillers that can be used are aluminum powder, alumina trihydrate, barium sulfate, silicates, calcium carbonate, kaolin clay, glass spheres, hollow glass spheres (glass spheres are also known as glass beads or glass bubbles and hollow glass spheres are also known as hollow glass beads or hollow glass bubbles), copper, talc, aluminum oxide, titanium oxide, carbon fibers, organic fibers, or the like, or combinations thereof. In an embodiment, more than one different type of filler can be used. In one preferred embodiment, the filler used is silica. In another embodiment, the composition may not comprise fillers.

Organic fillers may be in particulate or in fibrous form. Organic polymeric fillers may be selected from among polyolefins, poly(meth)acrylates, polyesters, polyamides, polyarylates, polyurethanes, or the like, or a combination thereof. Polymers can be homopolymers or block copolymers. In a preferred embodiment, the polymer fillers are miscible in the first and the second epoxide monomers. By selecting polymers that have lower melting points or lower glass transition temperatures than the temperature of the frontally polymerizing composition, the polymeric fibers may be melted or softened during the frontal polymerization process. This can cause a size redistribution of the fillers after polymerization compared with that before polymerization.

In an embodiment, the block copolymers can be a diblock or a triblock. Exemplary polymers include polymethylmethacrylate (PMMA), polystyrene-block-polybutadiene-block-poly(methyl methacrylate) or styrene-butadiene-styrene block copolymer.

In a preferred embodiment, the filler used is silica nanoparticles, such as for example, fumed silica. The silica nanoparticles are individually present in an amount of 0.1 to 5 wt %, preferably 0.5 to 4 wt % and more preferably 2.5 to 3.5 wt %, based on the total weight of the composition.

In another embodiment, the filler used are glass spheres, hollow glass spheres, or a combination thereof. The glass spheres or hollow glass spheres are used in an amount of 0.1 to 8 wt %, preferably 0.5 to 4 wt % and more preferably 2.5 to 3.5 wt %, based on the total weight of the composition. The use of fillers (e.g., such as for example, fumed silica or glass spheres (hollow or otherwise)) increases the foam porosity by an amount of greater than 10 volume percent, preferably greater than 20 volume percent, and preferably greater than 25 volume percent when compared with foamed compositions (having the same ingredients) but without the filler.

In an embodiment, the composition for the frontally polymerizing system comprises diluents. In the claimed composition, the objective of the diluent is to vary or determine the chemical, physical and mechanical properties of the composition. The diluents may be reactive (i.e., they can react with the low molecule weight molecules to be a part of the network) or be non-reactive. Examples of suitable diluents are alcohols, ethyl vinyl ether, n-butyl vinyl ether, isobutyl vinyl ether, octadecyl vinyl ether, cyclohexyl vinyl ether, dihydroxybutane divinyl ether, hydroxybutyl vinyl ether, cyclohexane dimethanol monovinyl ether, diethyleneglycol divinyl ether, triethyleneglycol divinyl ether, n-propylvinyl vinyl ether, isopropyl vinyl ether, dodecyl vinyl ether, diethyleneglycol monovinyl ether, cyclohexane dimethanol divinyl ether, trimethylolpropane trivinyl ether and vinyl ether, which can be obtained, for example, by the addition of acetylene to alcohols, as well as oligomers and polymers, which contain vinyl ether groups and are obtained, for example, by the addition of acetylene to hydroxyl group-containing oligomers and/or polymers or by the reaction of alkyl vinyl ethers with reactive monomers, oligomers and/or polymers, especially by the reaction of isocyanates and isocyanate prepolymers with hydroxy-functional alkyl vinyl ethers. In an embodiment, more than one different type of diluent can be used. In an embodiment, the composition does not comprise diluents.

In an embodiment, the diluent may be a polymer. Suitable polymers are thermoplastic polymers. Any of the polymers listed above may be used as a diluent, if so desired. The polymers generally have a weight average molecular weight of greater than 10,000 grams per mole, preferably greater than 15,000 grams per mole, and more preferably greater than 20,000 grams per mole.

In a preferred embodiment, the diluent used is a polyol. In various embodiments, the polyols available in the BASF commercial portfolio like Lupraphen®, Lupranol®, Pluracol® or combinations thereof can be used. In an embodiment, the hydroxyl number of the polyol is about 200-600 mg KOH/gram.

In a preferred embodiment, the diluent used is present in an amount of 0.5 to 5 wt %, preferably 5 to 15 wt % and more preferably 15 to 30 wt %, based on the total weight of the composition.

The composition may also contain additional ingredients such as crosslinking agents, hardeners, reactive or non-reactive diluents, fillers, fibers, chain transfer agents, UV stabilizers, UV absorbers, dyes, anti-ozonants, thermal stabilizers, inhibitors, viscosity modifiers, plasticizers, solvents, polymers, phase separating agents, surfactants, nucleating agents, microspheres or the like, or a combination thereof. The composition may be devoid of solvents or diluents if desired.

In an embodiment, surfactants are used. Surfactants can be anionic, non-ionic, and/or cationic surfactants. One of the criteria for selecting these surfactants is linear molecular structure to rule out any entropic effect originating possibly from molecular architecture.

Anionic surfactants comprise functional groups such as sulfate, sulfonate, phosphate, and carboxylates. Anionic surfactants include ammonium lauryl sulfate, sodium lauryl sulfate, sodium dodecyl sulfate, sodium laureth sulfate, sodium myreth sulfate, dioctyl sodium sulfosuccinate, perfluorooctanesulfonate (PFOS), perfluorobutanesulfonate, alkyl-aryl ether phosphates, alkyl ether phosphates. Anionic surfactants can also include carboxylate salts (soaps), such as sodium/potassium/calcium/magnesium/aluminum stearate, sodium lauroyl sarcosinate, perfluorononanoate, perfluorooctanoate (PFOA or PFO) and the like.

Non-ionic surfactants include alkyl polyglycoside, cetomacrogol 1000, cetostearyl alcohol, cetyl alcohol, cocamide DEA/MEA, glycerol monostearate, IGEPAL CA-630, Isoceteth-20, monolaurin, mycosubtilin, Nonidet P-40, Brij L4, nonoxynol-9, NP-40, octaethylene glycol monododecyl ether, N-Octyl beta-D-thioglucopyranoside, oleyl alcohol, PEG-10 sunflower glycerides, pentaethylene glycol monododecyl ether, poloxamer 407, polyethoxylated tallow amine, polyglycerol polyricinoleate, polysorbate, sorbitan, stearyl alcohol, surfactin, Triton X-100, Tween 80 and the like.

Cationic surfactants include behentrimonium chloride, benzalkonium chloride, benzethonium chloride, benzododecinium bromide, bronidox, carbethopendecinium bromide, cetalkonium chloride, cetrimonium bromide, cetrimonium chloride, cetylpyridinium chloride, didecyldimethylammonium chloride, dimethyldioctadecylammonium bromide, dimethyldioctadecylammonium chloride, dioleoyl-3-trimethylammonium propane, domiphen bromide, lauryl methyl gluceth-10 hydroxypropyl dimonium chloride, hexadecyltrimethylammonium chloride (HAC), hexa-decyltrimethylammonium bromide (HABr), and dodecylamine hydrochloride (DHCl), octenidine dihydrochloride, olaflur, N-oleyl-1,3-propanediamine, pahutoxin, stearalkonium chloride, tetramethylammonium hydroxide, thonzonium bromide and the like.

In a preferred embodiment, the surfactant is individually present in an amount of 0.1 to 10 wt %, preferably 1 to 8 wt % and more preferably 3 to 6 wt %, based on the total weight of the composition.

In a preferred embodiment, the foregoing polymers (which are formed upon activation by an external stimulus) are present in linear, branched or crosslinked form following polymerization. In an embodiment, the foregoing polymers are present in crosslinked form following polymerization.

In an embodiment, blowing agents comprising inorganic agents, organic blowing agents and chemical blowing agents can be used. Suitable inorganic blowing agents include carbon dioxide, nitrogen, argon, water, air, nitrogen, or helium. Organic blowing agents include aliphatic hydrocarbons having 1-6 carbon atoms, aliphatic alcohols having 1-3 carbon atoms, or fully and partially halogenated aliphatic hydrocarbons having 1-4 carbon atoms. Aliphatic hydrocarbons include methane, ethane, propane, n-butane, isobutane, n-pentane, isopentane, neopentane, and the like. Aliphatic alcohols include methanol, ethanol, n-propanol, isopropanol and the like. Fully and partially halogenated aliphatic hydrocarbons include fluorocarbons, chlorocarbons, or chlorofluorocarbons. Examples of fluorocarbons include methyl fluoride, perfluoromethane, ethyl fluoride, 1,1-difluoroethane (HFC-152a), 1,1,1-trifluoroethane (HFC-143a), 1,1,1,-2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane or the like. Partially halogenated chlorocarbons and chlorofluorocarbons for use in this invention include methyl chloride, methylene chloride, ethyl chloride, 1,1,1-trichloroethane, 1,1-dichloro-1 fluoroethane (HCFC-141b), 1-chloro 1,1-difluoroethane (HCFC-142b), 1-dichloro-2,2,2-trifluoroethane (HCFC-123) or 1-chloro-1,2,2,2-tetrafluoroethane (HCFC-124). Fully halogenated chlorofluorocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, dichloro-hexafluoropropane, or the like, or a combination thereof. Chemical blowing agents include azodicarboicarbonamide, azodiisobutyronitrile, barium azodicarboxylate, n,n′-dimethyl-n,n′-dinitrosoterephthalamide, and benzenesulfonhydrazide, 4,4-oxybenzene sulfonyl semicarbazide, p-toluene sulfonyl semicarbazide trihydrazino triazine, or the like, or a combination thereof.

In a preferred embodiment, the blowing agents comprise microspheres where the microsphere is individually present in an amount of 0.01 to 10 wt %, preferably 0.1 to 8 wt % and more preferably 0.5 to 2 wt %, based on the total weight of the composition.

In an embodiment, the nucleating agents comprising inorganic substances such as calcium carbonate, talc, clay, titanium oxide, silica, barium sulfate, diatomaceous earth, mixtures of citric acid, sodium bicarbonate, or the like can be used.

In a preferred embodiment, the foregoing polymers (which are formed upon activation by an external stimulus) are present in linear, branched or crosslinked form following polymerization. In an embodiment, the foregoing polymers are present in crosslinked form following polymerization.

In an embodiment, in one method of manufacturing an article, the composition for the frontally polymerizing system is prepared by mixing the two or more reactive species (e.g., the first epoxide and the second epoxide) with an initiator blend that comprises two or more initiators and a filler. The mixing of the reactants can be conducted in a reduced light environment and at a temperature conducive to dissolving the respective components. In a preferred embodiment, the mixing of the respective reactants continues until the mixture is homogenized.

In an embodiment, an external stimulus comprising electromagnetic radiation is used to activate the initiator within the homogenized mixture and to promote polymerization of the mixture. The electromagnetic radiation may be X-ray, electron beam, microwave, ultraviolet, visible, infrared radiation, or a combination thereof. UV radiation is preferred.

In a preferred embodiment, a 200 W UV lamp is used with a 250 to 450 nm wavelength filter. The intensity of the UV radiation is between 1 to 19 W/cm², most preferably the intensity between 9 to 10 W/cm².

In an embodiment, the external stimulus is heat energy. The external stimulus activates the initiator within the homogenized mixture and promotes polymerization of the mixture. The polymerization occurs between 180 to 300° C. The maximum temperature attained by the reaction front is about 180 to 300° C., more preferably 210 to 280° C. and most preferably 225 to 250° C.

As noted above, the elevated temperatures reached during polymerization promote evaporation of a portion of the reactants resulting in the formation of a foam. In an embodiment, blowing agents can be activated by the elevated temperatures resulting in additional foaming. By varying the amount of blowing agent, foams having different densities can be achieved. The foams can be open cell foams, closed cell foams, and foams having combinations of open and closed cells. The foams can be soft and flexible or can be rigid.

In an embodiment, the foams can have densities from 0.05 grams per cubic centimeter to 0.8 grams per cubic centimeter, preferably 0.1 grams per cubic centimeters to 0.5 grams per cubic centimeters, and more preferably 0.15 to 0.3 grams per cubic centimeters.

As noted above, the foams can be manufactured from a liquid composition or from a gelled composition. The gelled composition contains free radically polymerizable monomers in addition to the ionically polymerizable monomers (which are ionically polymerized to produce the foam). The free radically polymerizable monomers may be acrylates or fluoroacrylates. At least one or more of the acrylates used as a free radical polymerizable monomer has a functionality of greater than 2 or preferably greater than 3.

Examples of acrylates are bisphenol A glycerolate diacrylate, bisphenol A ethoxylate diacrylate, bisphenol A dimethacrylate, bisphenol A ethoxylate dimethacrylate, isobornyl acrylate (IA), tertiary butyl acrylate, tertiary butyl methacrylate (TBMA), trimethylolpropane triacrylate, pentaerythritol triacrylate, tetrahydrofurfuryl acrylate, tetrahydrofurfuryl methacrylate, or the like, or a combination thereof.

The acrylates are added to the composition in an amount of 1 to 15 weight percent, based on a total weight of the composition.

The gel composition may also contain a free radical initiator. The free radical initiators can be co-initiators—i.e., they can serve as initiators for the ionically polymerizable monomers too. An example of a free radical initiator for manufacturing of the gel foam is diphenyl(2,4,6-trimethylbenzoyl)phosphine oxide (TPO).

A desired article can be made by the homogenized composition. In an embodiment the article is a porous foam comprising multiple perforated cells. The porosity of the articles varies with the resin viscosity, front temperature, vapor density or factors alike.

In an embodiment, the multiple perforated cells can vary in size and shape. The cell size can be controlled by additional factors like one or more pointed, sharp objects. Suitable pointed, sharp objects include needles, spikes, pins, or nails.

The composition and the method of manufacturing disclosed herein are exemplified by the following non-limiting examples.

### EXAMPLES

The examples below demonstrate foam formation from the compositions disclosed herein.

### Example 1

This example demonstrates the polymerization of a mixture of a non-glycidyl epoxide and a second glycidyl epoxide via frontal polymerization. The example uses epoxycyclohexyl and diglycidyl ether functional monomers. The initiator system contains a free radical photoinitiator to crosslink the monomers. In this embodiment the cationic initiator is an onium salt derivative. The example uses a composition that comprises p-(octyloxyphenyl) phenyliodonium hexafluoroantimonate (IOC8 SbF6), 1,1,2,2-tetraphenyl-1,2-ethanediol (TPED), 3,4-epoxycyclohexanecarboxylate (ECC), and bisphenol A diglycidyl ether (DGEBA).

All of these components are soluble and can be mixed together and stored at room temperature under dark conditions. To ensure homogenization of the mixture, the mixture is heated between 55 to 65° C. for an hour. The homogenized mixture is kept in dark conditions, at room temperature, in the absence of UV light. When polymerization is desired, a UV source is applied to initiate frontal polymerization of the epoxy monomers. The frontal polymerization travels through the material beginning at the point of UV application. The composition used in this example can be stored up to a week. The materials used in the reaction and the resin formulation conditions are listed in the Table 1 below.

TABLE I

| Component | Function | Mass (%) |
|---|---|---|
| IOC8 SbF6 | Cationic Initiator | 2.00 |
| TPED | Co-initiator | 2.00 |
| ECC | Monomer | 57.60 |
| DGEBA | Monomer | 38.40 |

In this Example 1, a resin composition was prepared with the reactants of Table 1. This composition can be stored for extended periods of time. In this composition, IOC8 SbF6 and TPED was dissolved in ECC by mixing at 60° C. for approximately 1 hour. DGEBA was added to the homogenized mixture. Approximately 5.2 mL of resin was placed in a 11 mm inner-diameter glass test tubes marked vertically in 15 mm increments. Initiation was caused by UV irradiation from underneath the test tube. The polymerized front travels through the mixture beginning at the point of UV application.

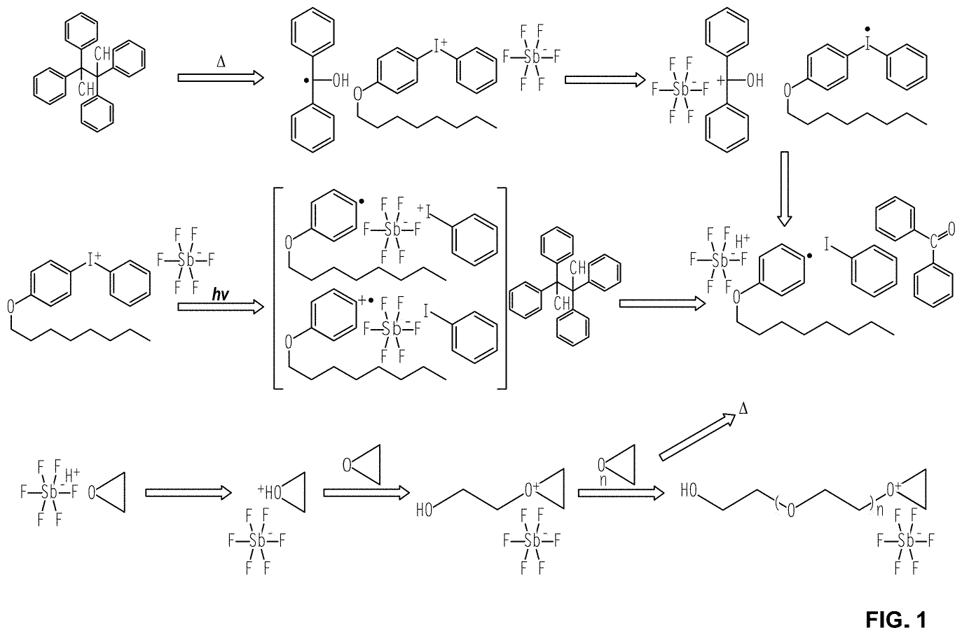

An exemplary frontal polymerization scheme is shown in FIG. 1. In FIG. 1, benzopinacol is used as a radical generator (a co-initiator used in the demonstrated embodiment) that undergoes heat dissociation and the resulting radicals formed aid in the oxidation of the cationic initiator. Additionally, a proton from the radical generator is also suspected to transfer to the metal complex of the cationic initiator and this results in the formation of the activated protonic acid which is depicted to initiate the curing of the epoxy system. The front is propagated from the heat released during the ring opening of the epoxy molecules, which is sufficient to dissociate the radical generator in the surrounding material and continue the propagating chain reaction. FIG. 1 shows that it is be possible to initiate the frontal polymerization either with heat or with UV radiation. In the demonstrated embodiment (Example 1) UV radiation was used.

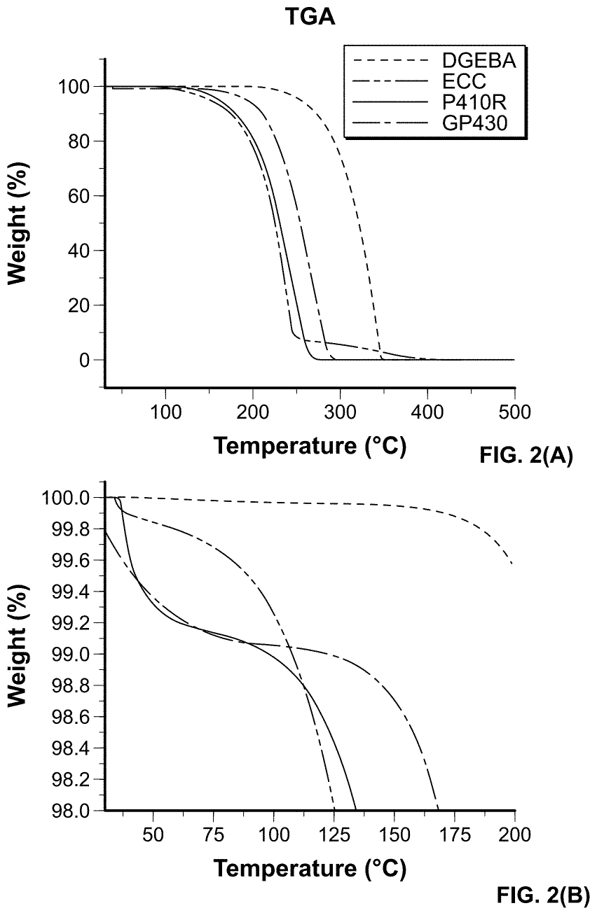

Thermogravimetric Analysis (TGA) was used to determine mass loss of resin components versus temperature. Heating scans were conducted from 0 to 250° C. at a rate of 10° C./min. FIG. 2A shows that each resin component exhibits mass losses at different temperatures. Much of the ECC monomer volatilizes by 250° C., while both polyols volatilize by 300° C. The DGEBA monomer shows the most thermal stability and volatilizes by 350° C. Additionally, both polyols and the ECC monomer show slight mass losses at lower temperatures, from 50-200° C. FIG. 2B provides an expanded view of early temperature mass losses.

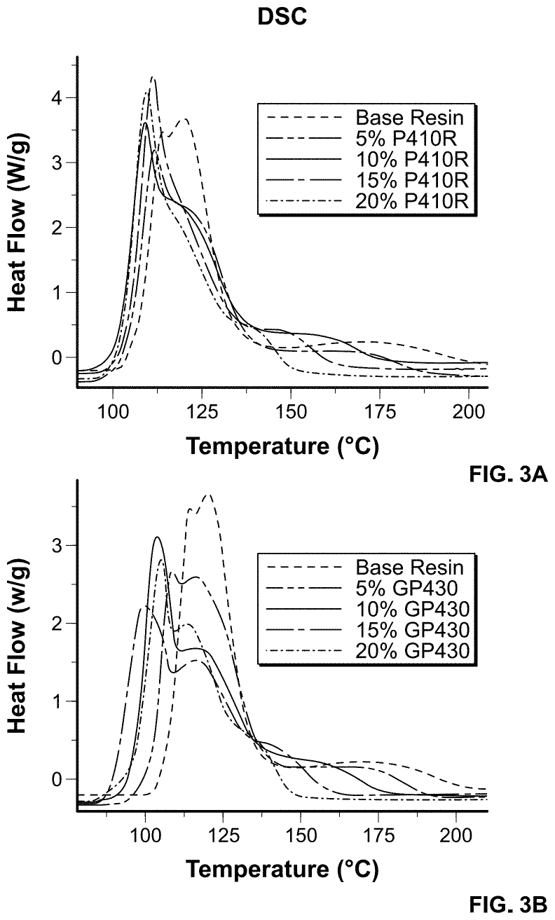

In FIGS. 3A and 3B, differential scanning calorimetry (DSC) was used to measure the exothermic energy of formulated resin. It also shows the effect of polyols on the polymerization reaction. FIG. 3A studies the effect of Pluracol® P410R (P410R) on the polymerization exotherm and FIG. 3B studies the effect of GP430 on the polymerization exotherm. Measurements from these DSC traces are tabulated in Tables II and III below. Table II shows tabulated measurements from DSC traces for P410R diluted formulations. Tₒ is the onset temperature of the exotherm, Tₚ is the exotherm peak temperature and energy is the integral of the corresponding peak. Table III shows tabulated measurements from DSC traces for Pluracol® GP430 (GP430) diluted formulations. Tₒ is the onset temperature of the exotherm, Tₚ is the exotherm peak temperature, and energy is the integral of the corresponding peak.

TABLE II

| P410R (wt %) | Tₒ (° C.) | Tₚ (° C.) | Energy (J/g) |
|---|---|---|---|
| 0 | 100 | 120 | 556 |
| 5 | 95 | 112 | 563 |
| 10 | 92 | 110 | 555 |
| 15 | 95 | 111 | 517 |
| 20 | 95 | 110 | 497 |

TABLE III

| GP430 (wt %) | Tₒ (° C.) | Tₚ (° C.) | Energy (J/g) |
|---|---|---|---|
| 0 | 100 | 120 | 556 |
| 5 | 91 | 108 | 590 |
| 10 | 85 | 103 | 551 |
| 15 | 83 | 99 | 507 |
| 20 | 81 | 104 | 450 |

It can be seen from Table II and Table III that the exothermic peak is achieved with the absence of polyol.

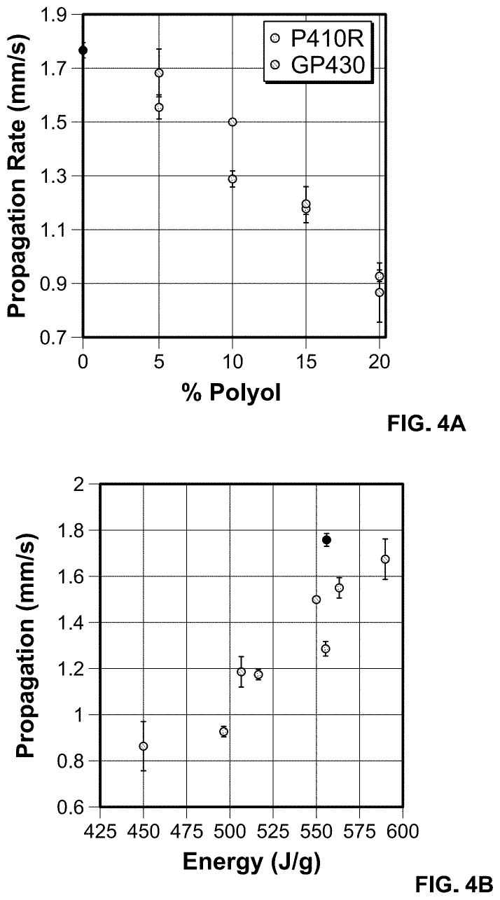

To investigate this further, effects of both polyol concentration and exothermic energy on front propagation rate was studied via FIGS. 4A and 4B.

The results of FIGS. 4A and 4B show a decreasing trend in propagation rate with increasing polyol composition. The rates appear to be independent of polyol functionality as propagation rates for each polyol are statistically similar at nearly all concentrations. This indicates that the polyols are acting as a nonreactive diluent rather than participating in the polymerization chemistry. Additionally, an increase in propagation rate with exothermic energy is observed.

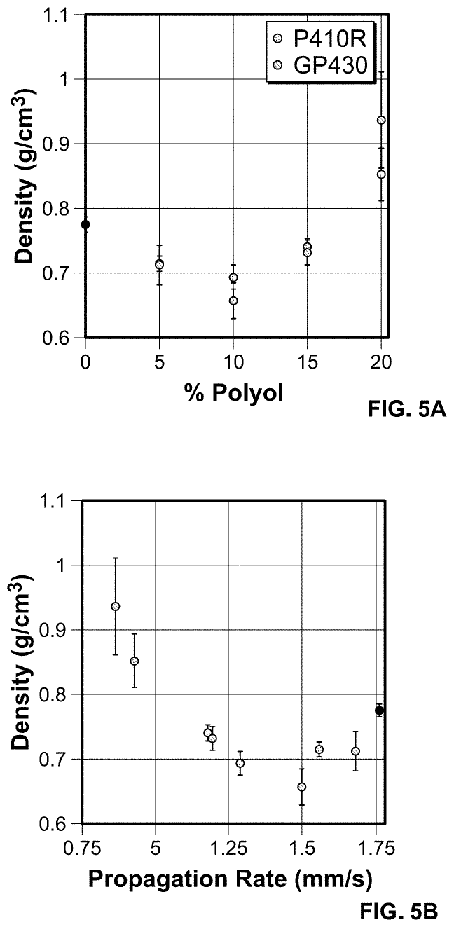

Foam density versus polyol composition and propagation rate is shown in FIGS. 5A and 5B respectively. It can be seen that the density was statistically similar for lower polyol dilutions but significantly increased at the largest polyol concentrations (20 wt %) where front propagation rate was slowest.

### Example 2

In this example, the role of the ratio of the monomers (ECC: DGEBA) in a reaction mixture is investigated further. The reaction mixture is prepared following the materials and method of Example 1. As depicted in Table IV, the amount of the monomers namely, ECC and DGEBA varies in the reaction mixture from 0 wt % to 100 wt %. Shortly, IOC8 SbF6 (initiator) was used in an amount of 2 wt % and TPED (co-initiator) was used in an amount of 2 wt %, the total weight % of the monomers is about 96 wt %, based on the total weight of the reaction mixture. The mixture of the initiator and the co-initiator was added to varying amounts of the monomers as shown in Table IV. The homogenized reaction mixture was placed in a 11 mm inner-diameter glass test tubes marked vertically in 15 mm increments followed by initiation by UV irradiation from underneath the test tube. Table IV shows variations of density and rate of propagation of the frontally polymerized epoxy resins with the concentration of the ECC monomer.

TABLE IV

| | Density | Rate of |
|---|---|---|
| Samples | (g/cm³) | propagation (mm/s) |
| ECC 0% (DGEBA:ECC = 10:0) | 1.18 | 0.67 |
| ECC 20% (DGEBA:ECC = 8:2) | 1.21 | 0.60 |
| ECC 40% (DGEBA:ECC = 6:4) | 1.19 | 0.79 |
| ECC 60% (DGEBA:ECC = 4:6) | 0.79 | 1.48 |
| ECC 80% (DGEBA:ECC = 2:8) | 0.49 | 2.58 |
| ECC 100% (DGEBA:ECC = 0:10) | 0.35 | 4.22 |

As seen in Table IV, as the content of ECC increases, the bulk density decreases, and the rate of propagation increases. It is noted that the volatile formation gets more noticeable with an increasing ratio of ECC to DGEBA especially beyond a critical concentration of the ECC at ca. 60 wt % the degree of volatile formation increases abruptly. According to Example 2, lower bulk densities at higher ECC ratios lead to the formation of porous cells.

It is well established that the mechanical strength of foams is inversely proportional to the average size of microcellular cells. Therefore, uniform microcellular morphology is of paramount importance in foams. Hence, further experiments were performed to optimally reduce the size of cells onto a microscopic scale while simultaneously maintaining sufficiently low bulk densities and desired mechanical properties.

### Example 3

To achieve a highly uniform microporous structure, fumed silica nanoparticles are added as a filler. In Example 3, silica nanoparticles up to 5 wt % were added to the polymerization mixture of Example 2, with the remainder being ECC and other ingredients shown in Table V. Table V below shows the concentration of the various ingredients used in samples 3a-3f. The polymerization reaction is carried out as shown in Example 1 and 2 above.

TABLE V

| Samples | 3a | 3b | 3c | 3d | 3e | 3f |
|---|---|---|---|---|---|---|
| ECC | 96 wt % | 95 wt % | 94 wt % | 93 wt % | 92 wt % | 91 wt % |
| DGEBA | 0 wt % | 0 wt % | 0 wt % | 0 wt % | 0 wt % | 0 wt % |
| IOC8 SbF6 | 2 wt % | 2 wt % | 2 wt % | 2 wt % | 2 wt % | 2 wt % |
| TPED | 2 wt % | 2 wt % | 2 wt % | 2 wt % | 2 wt % | 2 wt % |
| Fumed silica | 0 wt % | 1 wt % | 2 wt % | 3 wt % | 4 wt % | 5 wt % |
| nanoparticles | | | | | | |

Sample 3a with no silica exhibited similar morphology at the top and the bottom of the foam cross section. In contrast, samples containing silica nanoparticles (3b to 3f) exhibited a clear morphological difference between the top and bottom cross sections of the obtained foam.

The average size of the pores in the presence of fumed silica particles increases as the polymerization front moves upward and is similar to the morphology observed in 3a without the presence of nanoparticles.

It was also noted that the average size of pores in the presence of fumed silica is much smaller at the bottom than that at the top. This is largely attributed to the fact that since the UV source is initiated at the bottom of a test tube, the nanoparticles play a more decisive role in the regime closer to the initiation site. The smaller pore size at the bottom is also associated with a heterogeneous nucleation process that potentially occurs in the presence of nanoparticles.

Above 5 wt % of fumed silica, the viscosity of the resin becomes very high such that it is hard to conduct frontal polymerization in a test tube and at such high viscosity the preparation of a homogeneous resin is also difficult.

### Example 4

In Example 4, the effect of an additional surfactant was further tested. Table VI summarizes a list of surfactants examined.

TABLE VI

| Type of surfactants | Name | Chemical structure | Molecular weight (g/mol) |
|---|---|---|---|
| Anionic surfactants | Potassium stearate (KSt) | 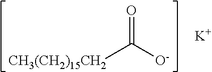 | MW = 323 |
| | Calcium stearate (CaSt) | 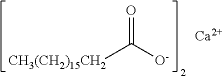 | MW = 607 |
| | Magnesium stearate (MgSt) | 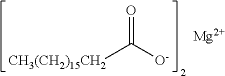 | MW = 591 |
| | Aluminum stearate (AlSt) | 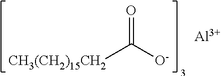 | MW = 877 |
| Non-ionic surfactants | Igepal CO-720 | 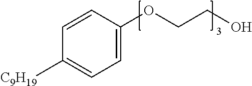 | Mn ~749 |
| | Brij L4 | 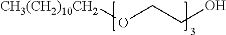 | Mn ~362 |
| Cationic surfactants | Hexadecyltrimethyl ammonium bromide (HABr) | 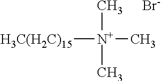 | MW = 364 |

In the base resin of Example 4, the ECC monomer is about 88 wt %, 2 wt % of IOC8 SbF6, 2 wt % of TPED, 3 wt % of fumed silica nanoparticles and a fixed surfactant concentration of 5 wt %, based on the total weight of the reaction mixture.

As observed, the base resin remains transparent after the addition of the two non-ionic surfactants (Igepal and Brij) surfactants, indicating their complete dissolution into the resin. However, the foaming behavior of the resin in the presence of these non-ionic surfactants is unaltered. Thus, this implies that the non-ionic additives play a negligible role in stabilizing the volatiles despite its good dispersion into the resin.

The base resin mixture of Example 4 obtained in the presence of a solid-state cationic and anionic surfactant respectively, is not homogenous. Nevertheless, a homogeneous dispersion is obtained by vigorous mixing at room temperature. In the presence of the solid-state cationic surfactant (HABr) the initiation and propagation of frontal polymerization is completely inhibited as the resin mixture remains unaltered even after exposure to UV. In contrast, with respect to the anionic surfactants, the height and cross-section of the prepared foams varies with the ionic charge number of their cation counterparts. It was concluded that the cell size of the pores decreases in the following order Al³⁺>Ca²⁺˜Mg²⁺>K⁺. Among the anionic surfactants examined, calcium stearate (CaSt) and magnesium stearate (MgSt) give the most uniform morphology throughout and also yield a smaller average size of pores.

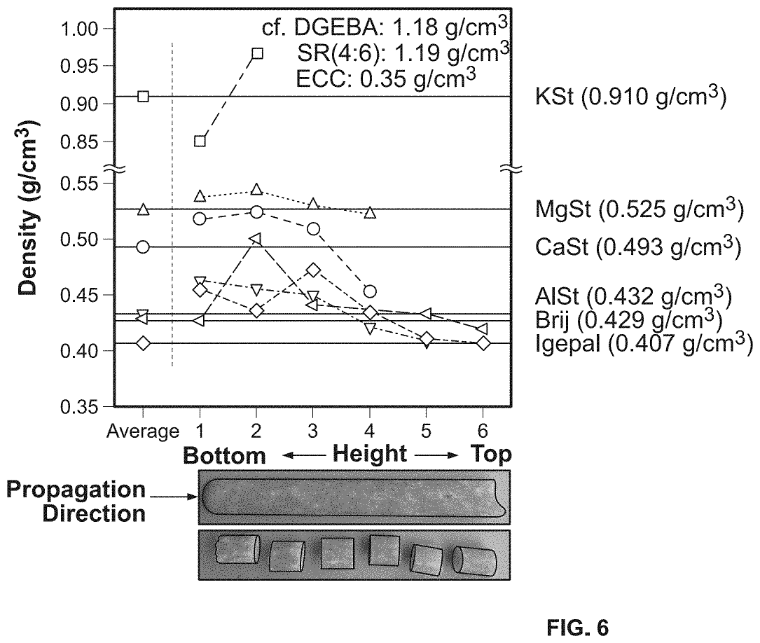

FIG. 6 shows the variation of the density of the epoxy foams prepared with different kinds of the surfactants, where the initiation direction is from the bottom to the top of the test tubes. The foam prepared with potassium stearate (KSt) gave the highest density whereas the foams containing the non-ionic surfactants yield the lowest bulk density followed by those with aluminum stearate (AlSt). In general, the foam prepared with AlSt is also too brittle in strength comparable to the foam made from the 100% ECC without any additive. CaSt and MgSt provide foams with bulk density values of ca. 0.5 g/cm³. This is a much smaller value compared to the density of neat DGEBA or the standard resin (ECC 60%).

Unlike the cationic surfactant, the frontal polymerization can be initiated and propagate with the anionic and non-ionic surfactants. In case of the non-ionic surfactants, they seem to have little to do with the foaming behavior of the epoxy resin because its height after the polymerization and its cross-sections are both quite similar with those obtained with the 100% ECC without surfactant. Thus, this implies that the non-ionic additives would play a negligible role in stabilizing the volatiles despite its good dispersion into the resin.

Potassium stearate (KSt) seems to highly restrain the formation of volatiles leading to the final height of the polymerized sample similar with that of the resins with a much smaller amount of ECC less than 60 wt %. Among the anionic surfactants examined, calcium stearate (CaSt) and magnesium stearate (MgSt) give the most uniform morphology throughout the whole specimen and also yield a smaller average size of pores. In these samples, however, the large hole made at the center of these cylindrical samples should be removed or at least minimized to prepare foams with high homogeneity in mechanical strength.

In case of the cationic surfactant (HABr), the resin turns translucent while the addition of the anionic surfactants makes the resin highly opaque. It is observed that the presence of HABr completely inhibits the propagation of frontal polymerization and even its initiation. The resin remains absolutely the same even after the exposure to the UV source at the bottom of the test tube.

### Example 5

Example 5 was conducted to obtain a uniform foam in the presence of CaSt and MgSt. The viscosity of the base resin is adjusted by using a base resin that comprises monomers present in an amount of about 88 wt %, based on the total weight of the composition. The distribution of the monomers is such that the ECC is present in an amount of 80 wt % and DGEBA is present in an amount of 20 wt %, based on the total weight of the monomers present in the composition. The composition of Example 5 further comprises, 2 wt % of IOC8 SbF6, 2 wt % of TPED, 3 wt % of fumed silica nanoparticles and 5 wt % of CaSt, based on the total weight of the composition. With this altered viscosity, the large hole at the center as seen in Example 4 almost disappears. At the same time, however, it seems that the number of pores is also decreased because of the reduced amount of ECC which is particularly responsible for volatile formation.

### Example 6

Example 6 was conducted to determine if the pre-melting effect of MgSt improves dispersion efficiency. The base resin comprises monomer in an amount of 88 wt %, based on the total weight of the composition. The monomer comprises ECC only. The composition further comprises 2 wt % of IOC8 SbF6, 2 wt % of TPED, 3 wt % of fumed silica nanoparticles and 5 wt % MgSt, based on the total weight of the composition. Two test conditions were evaluated 1) without a pre-melting step wherein all the reactants are mixed at 65° C. similar to the Example 4; and 2) with a pre-melting step of MgSt, where the MgSt was heated at 90° C. for efficient dispersion. For the pre-melted specimens, two runs were conducted to improve dispersion.

It was observed that even after the pre-melting procedure, the base resin mixture was opaque but the size of dispersed MgSt particles reduced slightly. Despite the enhanced dispersion, the insertion of the pre-melting step has negligible effect on the porosity level and the average size of cells and the presence of a large hole at the center as observed in Example 4 remained unaltered.

### Example 7

In Example 7, the effects of changing the initiation site of the frontal polymerization was investigated. The UV initiation site is changed from the bottom to the top of a test tube. The base resin comprises the monomer present in an amount of 88 wt %, based on the total weight of the composition. The monomer is ECC only. The remainder of the composition is 2 wt % of IOC8 SbF6, 2 wt % of TPED, 3 wt % of fumed silica nanoparticles and 5 wt % MgSt or CaSt, based on the total weight of the composition.

This method seems highly efficient in reducing the average size of cells as well as in eliminating the emergence of the large hole at the center in the presence of CaSt as well as MgSt. However, the bulk density slightly increases from 0.49 g/cm³ to 0.6 g/cm³ in case of CaSt and from 0.53 g/cm³ to 0.64 g/cm³ in case of MgSt. Furthermore, one of the biggest problems of changing the initiation sites particularly in case of using a test tube was an incomplete polymerization reaction.

To overcome incomplete polymerization in a test-tube the same reaction was carried out in a petri dish on a larger scale. Unlike the foam prepared with a test tube, these products were much more uniform in bulk morphology. Further, it is worth noting that the propagating heat from the polymerization partially melted the petri dish, thereby exhibiting a strong in-situ adhesion between the epoxy foam and the polystyrene substrate found in the petri dish.

### Example 8

In Example 8, the effect of microspheres is tested on the foaming process. Base resin consisted of varying ratios of DGEBA: ECC, such that the amount of the monomers present is about 95 wt % based on the total weight of the composition. The composition further comprises 2 wt % of IOC8 SbF6, 2 wt % of TPED and 1 wt % of DU-120, an expandable microsphere, based on the total weight of the composition. Table VII lists the ratios of ECC:DGEBA with the densities observed in the presence of a microsphere.

TABLE VII

| DGEBA:ECC | Density (g/cm3) |
|---|---|
| 100:0 | 0.777 |
| 80:20 | 0.73 |
| 60:40 | 0.53 |

The use of a microsphere for foam formation is a one-step process as it utilizes the polymerization heat of the frontally polymerizable epoxy resin for the expansion of the outer thermoplastic shell of the microspheres which in turn leads to the formation of a finely controlled foam structure. In the presence of microspheres in an amount of 1 wt % even neat DGEBA without ECC could be foamed, neither nanoparticle nor surfactant was added in this case. The degree of foaming increases almost linearly with increasing the ratio of ECC to DGEBA and the cross-sections of the epoxy foams obtained are quite uniform but in case of 60% ECC samples, brown color is observed around the center of the test tube which may imply the probability of thermal degradation of the thermoplastic shell of the microspheres under the high temperature of the frontal polymerization process.

### Example 9

This is another example that demonstrates the polymerization of a mixture of a non-glycidyl epoxide and a second glycidyl epoxide via frontal polymerization. The example uses epoxycyclohexyl and diglycidyl ether functional monomers. The initiator system contains a free radical photoinitiator to crosslink the monomers. In this embodiment the cationic initiator is an onium salt derivative. The example uses a composition that comprises p-(octyloxyphenyl) phenyliodonium hexafluoroantimonate (IOC8 SbF6), 1,1,2,2-tetraphenyl-1,2-ethanediol (TPED), 3,4-epoxycyclohexanecarboxylate (ECC), and bisphenol A diglycidyl ether (DGEBA).

The resin components shown in this example and the following examples are detailed below (including the supplier from whom the components were purchased where possible). Trimethylolpropane triacrylate (TPT), diphenyl(2,4,6-trimethylbenzoyl)phosphine oxide (TPO), tertbutyl methacrylate (TBMA), fumed silica, magnesium stearate (MgSt), calcium stearate (CaSt), potassium stearate (KSt), aluminum stearate (Last), IGEPAL CO-720, BRIJ L4,talc, 3,4-epoxycyclohexylmethyl 3,4-epoxycyclohexanecarboxylate (ECC) and 1,1,2,2-tetraphenyl-1,2-ethanediol (TPED) was purchased from MilliporeSigma. Bisphenol A diglycidyl ether (DGEBA) was purchased from Olin Epoxy and p-(octyloxyphenyl) phenyliodonium hexafluoroantimonate (IOC₈ SbF₆) was purchased from Gelest. Chemical blowing agents (CBA) Safoam RAZ-P was purchased from Reedy Chemical, syntactic foam additive iM30K Glass bubbles were purchased from 3M and stabilizer Vorasurf DC 193 additive was purchased from DOW Chemical. All materials were used as supplied, without further purification.

Resin formulations were created in amber scintillation vials in a stirring well. The desired amounts of IOC₈ SbF₆, TPED and RAZ-P were added as powders to the ECC and DGEBA monomer. Desired amounts of DC 193 were added and homogenized by mixing in dark conditions for one hour at 60° C. All samples were then kept in dark conditions, at room temperature, in the absence of UV light until testing. When testing, frontal polymerization (FP) was initiated via UV irradiation using a Lumen Dynamics OmniCure S1500 UV source set at 50% intensity with a 250-450 nm filter. The base formulation composition is outlined in Tables VIII and IX below

Table VIII details the base liquid resin formulation composition excluding chemical blowing agents (CBAs) and additives while Table IX details the base liquid resin formulation chemical blowing agents and additives.

TABLE VIII

| | | Mass (%) Cationic |
|---|---|---|
| Component | Function | Component |
| IOC8 SbF6 | Cationic Initiator | 2.00 |
| TPED | Co-initiator | 2.00 |
| ECC | Monomer | 57.60 |
| DGEBA | Monomer | 38.40 |

TABLE IX

| Component | Function | Mass (%) |
|---|---|---|
| RAZ-P | CBA | 0, 0.5, 1, 2 |
| DC 193 | Stabilizer | 0, 0.5, 1 |
| iM30K | Hollow glass filler | 0, 2 |
| Fumed Silica | Stabilizer | 0, 3 |
| MgSt | Anionic Surfactant | 0, 5 |
| KSt | Anionic Surfactant | 0, 5 |
| CaSt | Anionic Surfactant | 0, 5 |
| AlSt | Anionic Surfactant | 0, 5 |
| Igepal CO-720 | Cationic Surfactant | 0, 5 |
| Brij L4 | Cationic Surfactant | 0, 5 |

The gel resin formulation was manufactured as follows. Resin formulations were manufactured in amber scintillation vials in a stirring well. Desired amounts of DPO, IOC₈ SbF₆, TPED and RAZ-P were added as powders to the ECC and DGEBA monomer. The desired amounts of DC 193 TPT and either TBMA or IA were added and homogenized by mixing in dark conditions for one hour at 60° C. All samples were then kept in dark conditions, at room temperature, in the absence of UV light until testing. When testing, gelling was achieved using UVA radiation.

Foam formation from the gel is conducted as follows. Frontal polymerization (FP) was initiated via UV irradiation using a Lumen Dynamics OmniCure S1500 UV source set at 50% intensity with a 250-450 nm filter. The base formulation compositions are outlined in Tables 10, 11 and 12.

Table 10 shows an acrylate gel formulation which eventually is 5 wt % of total formulation. The formulation shown in Table 10 excludes CBA and additives.

TABLE 10

| Component | Function | Mass (%) of Gel |
|---|---|---|
| TPT | Crosslinker | 47.5 |
| TBMA | Acrylate Monomer | 47.5 |
| DPO | Initiator | 5 |

Table 11 details the cationic formulation which contributes to 95 wt % of total formulation excluding CBA and additives.

TABLE 11

| | | Mass (%) Cationic |
|---|---|---|
| Component | Function | Component |
| IOC8 SbF6 | Cationic Initiator | 2.5 |
| TPED | Co-initiator | 2.5 |
| ECC | Monomer | 95, 57, 38, 19, 0 |
| DGEBA | Monomer | 0, 38, 57, 76, 95 |

Table 12 shows the chemical blowing agents and additives.

TABLE 12

| | | Mass (%) of total |
|---|---|---|
| Component | Function | formulation |
| RAZ-P | CBA | 0, 0.5, 1, 2 |
| DC 193 | Stabilizer | 0, 0.5, 1 |
| iM30K | Hollow glass filler | 0, 2, 5 |
| MgSt | Anionic Surfactant | 0, 2, 5 |
| Talc | CBA | 0, 2 |

Frontal polymerization (FP) was conducted as follows. Approximately 3.7 mL of liquid resin was placed in 11 mm inner-diameter glass test tubes marked vertically in 3 millimeter (mm) increments. Initiation was done using UV irradiation from underneath the test tube. Video recordings were conducted during each polymerization. When FP was completed, the sample was undisturbed for a minimum of ten minutes to cool to room temperature before removal from the test tubes. Once removed, specimens were cut to cylindrical geometries and density measurements were performed.

For gelled samples, circular molds 25 mm in diameter and 3 mm in thickness were filled with resin. The resin was held under UVA radiation for 10-60 minutes. The gels were initiated on a variety of substrates from one end of the circular disk using UV irradiation. When FP was completed, the sample was undisturbed for a minimum of ten minutes to cool to room temperature. The samples were then cut into rectangular specimens and density measurements were performed.

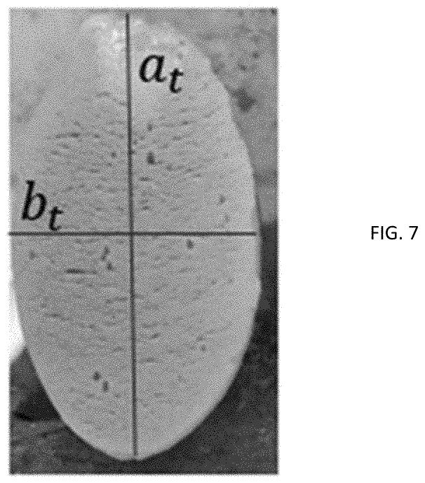

After frontal polymerization of the gelled samples, the maximum length and width were measured to determine the level of anisotropy. The accompany equations for determining the anisotropy factor are outlined below with regard to FIG. 7, which depicts a schematic diagram for measuring foam anisotropy. The equations are shown below.

$${A}_{f} = \frac{{a}_{t} / {a}_{0}}{{b}_{t} / {b}_{0}} \qquad ( 1 )$$

$${a}_{0} = {b}_{0} \qquad ( 2 )$$

$${A}_{f} = \frac{{a}_{t}}{{b}_{t}} \qquad ( 3 )$$

where a₀ and b₀ are the initial semi-major and semi-minor axes, and aₜ and bₜ are the final semi-major and semi-minor axis. Due to the initial circular shape of the gelled sample, a₀ is equal to b₀ which is also equal to the diameter.

Other forms of analysis conducted on the frontally polymerized foams are detailed below.

Differential Scanning Calorimetry (DSC) was performed on a TA instruments Q200 DSC and was used to measure the glass transition of frontally polymerized foams from liquid and gel resins. Heating scans were conducted from 0 to 300° C. at a rate of 10° C./min.

Uniaxial compression testing was performed on a Instron 5500R, using a 1 kiloNewton (kN) load cell and compression clamps. Sample were prepared to 2 to 1, length to diameter in dimension. The tests were performed at a rate of 2.5 mm/minute until failure.

25 mm parallel plate rheology on gelled specimens were performed on samples with different gelling times. The tests were tun with a normal force of 50 Pa and a frequency sweep of 1-100 Hz.

SEM images were captured of both the liquid and gel formulation FP foams using a Magellan 400 SEM. Both samples were cryofractured by immersing them in liquid N2 and then using a razor and hammer to fracture the samples. SEM samples were made to view cross sections perpendicular and parallel to the front direction. Before imaging the samples were coated using gold sputter coating. Pore analysis was done to get pore size distribution along with a shape factor to determine pore shape homogeneity and anisotropy. The accompany equations for determining the shape factor are outlined:

$${R}_{p} = \frac{Perimeter}{2 π} \qquad ( 4 )$$

$${R}_{a} = \sqrt{\frac{Area}{π}} \qquad ( 5 )$$

$$Shape Factor = \frac{{R}_{p}}{{R}_{a}} \qquad ( 6 )$$

Where Rₚ represents the radius derived from the perimeter of each pore and Rₐ represents the radius derived from the area of each pore.

### Example 10

This example details the amount of foaming that occurs when the ratio of glycidyl epoxide (ECC) to the non-glydicyl epoxide (DGEBA) is varied. This Example is the same as Example 2 and was conducted in a similar manner but contains additional details and micrographs. Table 13 below details the different rations of the ECC to DGEBA.

TABLE 13

| | Density | Rate of |
|---|---|---|
| Samples | (g/cm³) | propagation (mm/s) |
| ECC 0% (DGEBA:ECC = 10:0) | 1.18 | 0.67 |
| ECC 20% (DGEBA:ECC = 8:2) | 1.21 | 0.60 |
| ECC 40% (DGEBA:ECC = 6:4) | 1.19 | 0.79 |
| ECC 60% (DGEBA:ECC = 4:6) | 0.79 | 1.48 |
| ECC 80% (DGEBA:ECC = 2:8) | 0.49 | 2.56 |
| ECC 100% (DGEBA:ECC = 0:10) | 0.35 | 4.22 |

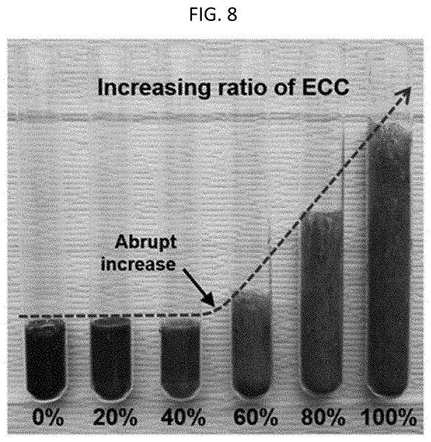

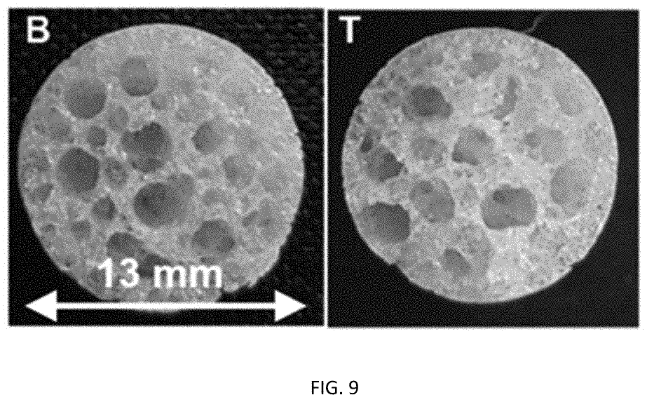

From the Table 13 it may be seen that when the ratio of ECC to DGEBA increases sharply above 4:6, the rate of propagation increases rapidly. The density of the foam also decreases rapidly above this ratio. The difference in the foam density may be seen in the FIG. 8. The FIG. 8 shows the foams formed as a function of the weight percent of the initial amount of ECC. FIG. 8 depicts the variation of height of frontally polymerized products prepared from epoxy mixtures with different ratios of ECC to DGEBA (whose initial heights prior to the polymerization were almost the same). Considering that the formation of volatiles undoubtedly increases the height of the resin after the polymerization, it is apparent from the FIG. 8 that the volatile formation gets more noticeable with increasing the ratio of ECC to DGEBA. It is also interesting to see that there seems to exist a critical concentration of ECC at approximately 60 wt %, above which the degree of volatile formation increases abruptly. As the content of ECC increases, the bulk density decreases and the rate of propagation increases. Lower bulk densities at higher ECC ratios also verify the formation of porous cells. As can be reconfirmed by a cross sectional image depicted in the FIG. 9, the resin prepared from 100% ECC contains lots of pores. Without any additive, their size is quite irregular and some of large pores are about to 2 to 3 mm in diameter. As a result, the specimens prepared from the resin with an excess amount of ECC are brittle so they are easily broken down into pieces even while being taken out of the test tube.

### Example 11

This Example depicts the use of fumed silica and is similar to Example 3. The manufacturing was conducted in the same manner as Example 3. Additional details as to the morphology are provided here. This example was conducted to determine whether fillers could produce uniform porosity in foams manufactured from a glycidyl epoxide (ECC). The original foam composition contained only fumed silica in different amounts (in addition to ECC). The silica is added in amounts of 0, 1, 2, 3 and 4 wt % with the remainder being ECC. Samples were taken from the bottom and top of the test tube in which the foams were produced.

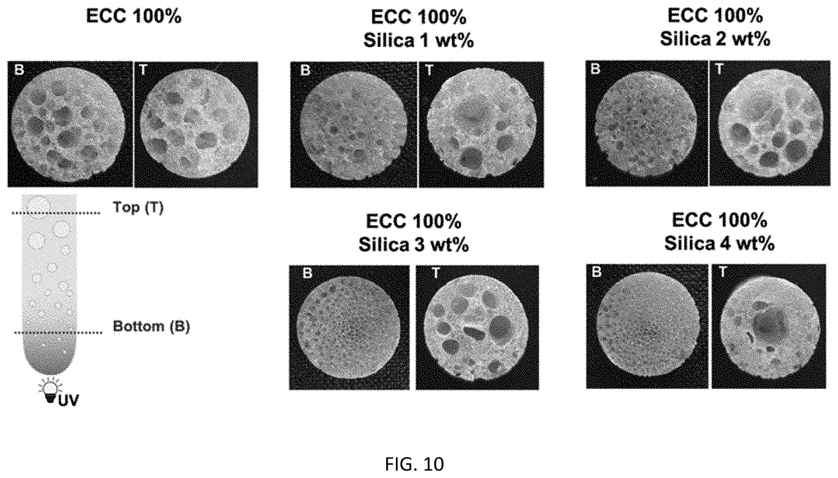

FIG. 10 shows the effects of adding fumed silica nanoparticles at several concentrations up to loading level of 4 wt %. Above 5 wt %, the viscosity of the resin is too high which inhibits frontal polymerization in a test tube. Due to the high viscosity, the difficulty of complete removal of air bubbles trapped during the mixing procedure is also inadequate to investigate foaming behavior at higher concentrations of fumed silica nanoparticles.

In FIG. 10, two distinct cross-sections are given for each sample which were respectively taken from the top and bottom sections of test tubes as schematically described in the inset of the Figure. The 100% ECC specimen exhibits a similar morphology at the top and bottom, whereas FP foams containing silica nanoparticles seem to show a clear morphological difference between them. The average size of the pores is much smaller at the bottom than at the top. Considering the fact that the UV source was initiated at the bottom of a test tube, it may be suggested that nanoparticles play a more decisive role in the regime closer to the initiation site. The reduced cell size at the bottom would result from heterogeneous nucleation process, which is expected when adding nanoparticles. By the same principle, the surface of fumed silica nanoparticles in the epoxy mixture would provide sites for cell growth, which seems to be efficient predominantly near the UV initiation site. As the polymerization front moves upward, one can clearly observe in FIG. 10 that the average size of cells gets larger again and returns to the morphology similar with that observed by the 100% ECC without the nanoparticles.

The increasing size of cells along the upward movement of polymerization front is ascribable to an increasing coalescence of air bubbles with time. The easy coalescence of generated gases is simply due to a lack of stabilizers which could reduce the interfacial tension between epoxy resin and formed gases and prevent gases from merging with one another.

### Example 12

This example was conducted to demonstrate the effect of surfactant on density. The foam composition contained tertiary butyl methacrylate (TBMA) (5 wt %) and ECC with 2% of either talc or magnesium stearate (MgSt). The results are shown in the Table 14 below.

TABLE 14

| Surfactant | Density (g/mL) | Porosity (%) | Anisotropy Factor |
|---|---|---|---|
| 2% Talc | 0.94 | 16.32 | 1.34 |
| 2% MgSt | 0.9 | 20.1 | 1.52 |

Talc and MgSt provided low amounts of porosity with only 16 to 20% porous materials. Along with the low porosity the anisotropy factor was very low for the 2% talc sample. While the MgSt sample had an anisotropy factor of 1.52, other additives such as specific chemical blowing agents would provide a higher porosity along with a larger anisotropy factor.

### Example 13

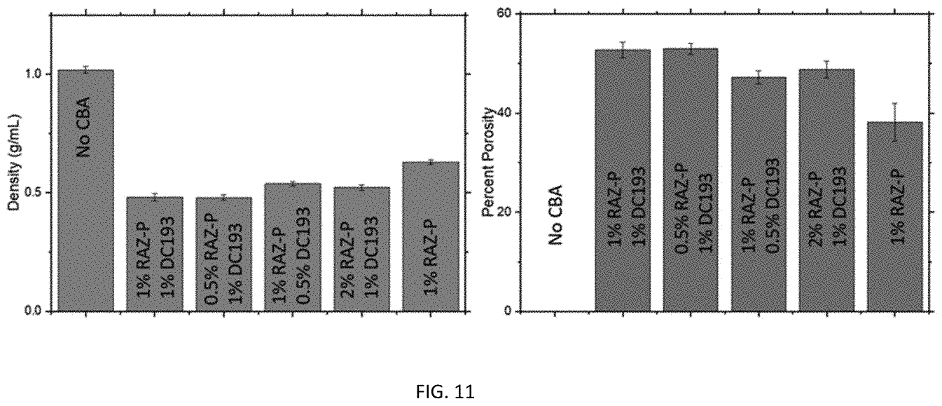

This example details foam density for liquid and gel compositions that are frontally polymerized. The liquid compositions comprise 60:40 ECC:DGEBA, 0.5 to 2 wt % RAZ-P, 0.5 to 1% DC 193 in glass test tube and cut into samples along the length of the tube. Density of the samples was measured from the bottom most sample to the top most sample. A total of 5 samples of 1 inch in height was used for density measurements. The density and porosity results are shown in the FIG. 11. The density results indicate that combinations of chemical blowing agent RAZ-P and stabilizer DC 193 result in the lowest density foams leading to the highest porosity above 50%. 1% RAZ-P and 0.5% RAZ-P with 1% DC 193 formulations resulted in the lowest densities and qualitatively best developed foams.

The gel compositions comprise only ECC (with no DGEBA) to only DGEBA (with no ECC), with intermediate ratios of ECC:DGEBA of 60:40, 40:60, 20:80; with 0.5 to 2 wt % RAZ and/or 0.5 to 1 wt % DC193 in initial gel form. The preparation of gels is detailed in Example 17. The UV irradiation is held at one end of the gelled disk. As the initiation front propagates forward volatiles formed and traveled vertically upward as the exotherm continues forward along the gel. As this occurred, the length of the sample increased along the front direction. This indicates that porosity was caused by volatile formation during FP, generating a foam upon curing.

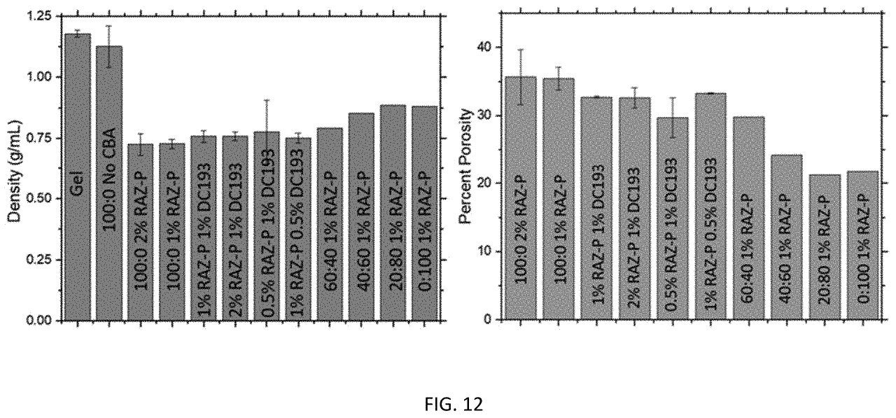

FIG. 12 details the density and porosity results for foams derived from the UV curing of gels. The results indicate that as the concentration of DGEBA increases, the density increases resulting in a decrease in porosity to ˜20%. The formulations that consisted of only ECC as the cationic monomer and RAZ-P as the only additive displayed the lowest densities and highest porosities of ˜36%.

### Example 14

This example demonstrates the anisotropy of an initially gelled composition. The composition along with the anisotropy is shown in the Table 15 below.

TABLE 15

| Chemical Blowing Agent | ECC:DGEBA | Af |
|---|---|---|
| 1% RAZ-P | 100:0 | 1.62 |
| 1% RAZ-P | 60:40 | 1.62 |
| 1% RAZ-P | 40:60 | 1.43 |
| 1% RAZ-P | 20:80 | 1.35 |
| 1% RAZ-P | 0:100 | 1.23 |
| 2% RAZ-P | 100:0 | 1.84 |
| 1% RAZ-P, 1% DC 193 | 100:0 | 1.66 |
| 2% RAZ-P, 1% DC 193 | 100:0 | 1.58 |
| 0.5% RAZ-P, 1% DC 193 | 100:0 | 1.82 |
| 1% RAZ-P, 0.5% DC 193 | 100:0 | 1.53 |

The direction of the propagating front led to a larger increase in length. The initiation site exhibited control of the level of anisotropy. When initiated in the center of the sample the initiation front propagated evenly to the edges resulting in the sample cracking due to the expansion of the foam instead of elongating. This resulted in anisotropy throughout the foam and a demonstrates a method to control this anisotropy. The formulations consisting of 100% ECC as the cationic monomer resulted in higher anisotropy, along with samples that consisted of only RAZ-P or a combination of RAZ-P and DC 193 where they were in equal parts or a higher percentage of DC 193. The foam shows an anisotropy of up to 1.5, preferably of up to 1.6 and more preferably of up to 1.8.

### Example 15

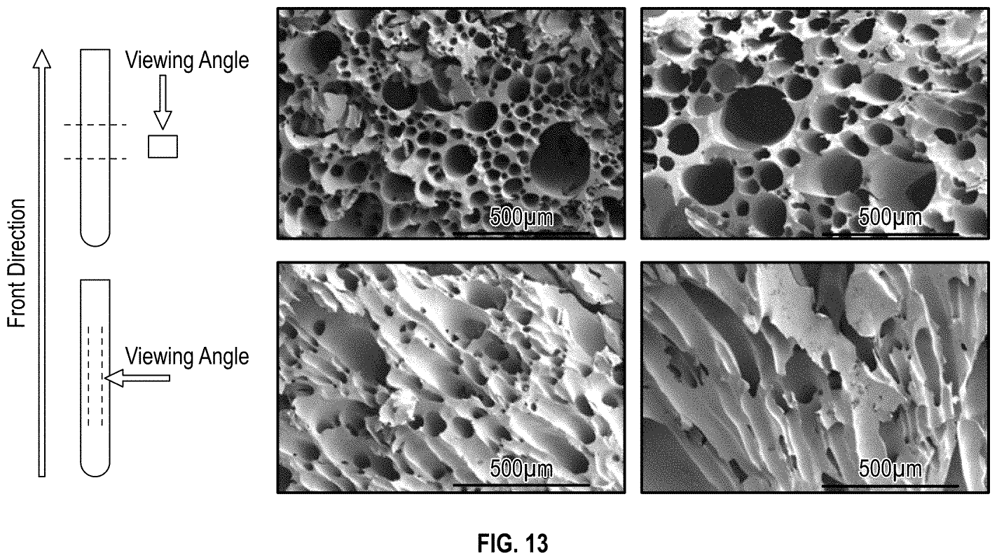

This example demonstrates the microcellular structure of the foams. Scanning electron microscopy (SEM) was conducted to study the microcellular structure of the FP foams. Samples were cryo-fractured parallel and perpendicular to the propagation front direction. This was done to investigate the differences in cell morphology throughout the sample, providing information on the level of anisotropy along with cell size and shape. FIG. 13 depicts SEM images of 60:40 ECC:DGEBA, 1% RAZ-P, 1% DC 193 liquid formulation samples cryofractured parallel (top) and perpendicular (bottom) to the front direction. Gel samples (not shown here) were also cryo-fractured and examined using SEM.

SEM images of cross sections parallel and perpendicular to the front direction display anisotropy in the microstructure of both the liquid and gel FP foams. Both formulations demonstrate different pore size and shape between the two cross sections. The liquid formulation FP foam fractured parallel to the front direction exhibits circular pores that appear to be bimodal in size ranging from 100 μm² to 5000 μm² and then again from 5000 μm² to 50,000 μm². While there are many less pores within the second area range, the size of them is significantly greater thereby reducing the number of possible pores within that specified size range. The shape factor displays a majority of pores below 1.5 and almost all below 2. This signifies the pores are closer to circular in nature and more homogeneous in shape. Perpendicular to the front direction has fewer if any pores and appears to present channels for the pores displayed parallel to the front direction.

The gelled FP foam possesses smaller irregularly shaped pores parallel to the front direction which range from 18 μm² to just over 8,000 μm². The pore shape factor has a tight distribution below 2 exhibiting more homogeneous pore shape, with few pores with a shape factor over 2. Perpendicular to the front direction, the sample displays a combination of smaller irregular shaped pores with much larger pores that follow along the same direction. The wider range of size, from 56 μm² to 23,000 μm². The pore shape factor also has a larger distribution above 2, demonstrating less homogeneity between pore shape. The significant differences between the size distribution of the different cross sections along with the irregularity in pore shape shown by the shape factor proves anisotropy within the gelled samples.

In conjunction with the anisotropy, there are major difference between the liquid formulation and gel formulation FP foams. The size and shape of the pores are different parallel and perpendicular to the front direction. The liquid samples have much larger pores parallel to the front direction, while perpendicular to the front direction the liquid samples how almost no pores while the gel FP sample has larger more irregularly shaped pores. The shape factor distribution is also closer to 1 for the liquid samples due to the more uniform pore shape as compared to the gel FP foams.

### Example 16

This example demonstrates the use of glass beads as additives on liquid and gelled foams. The glass beads (also called iM30K glass bubbles) are hollow glass spheres that are used for the development of syntactic foams. Syntactic foams result in lower density than solid samples while maintaining higher specific strength due to the strength of the hollow glass spheres. The addition of 2% iM30K in the gel formulation without another chemical blowing agent increased the porosity by 16.5% as compared to a solid sample.

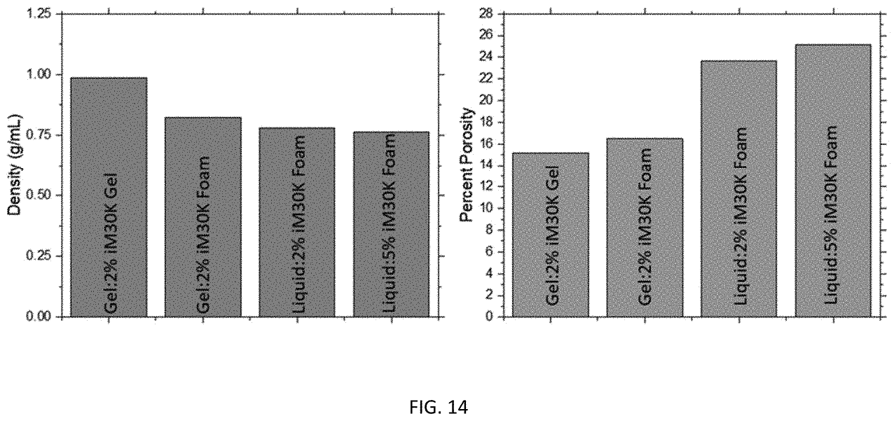

The addition of 2% iM30K glass bubbles into the base liquid formulation increased the porosity by 23.6% without another chemical blowing agent necessary. 5% iM30K glass bubbles resulted in an increase of porosity by 25.2%. 5% was also the maximum concentration of the iM30K glass bubbles into the liquid formulation before the liquid resin was unable for frontally polymerize. FIG. 14 is a bar graph that shows the effect of hollow glass beads (also called iM30K glass bubbles) on density and porosity liquid and gel formulation FP foams.

### Example 17

This example demonstrates the manufacturing of a foam from a gel composition. The gel composition results in a foam that has a double network—one network formed from acrylates while the other network is formed from epoxides. 1,1,2,2-tetraphenyl-1,2-ethanediol (TPED) is used as a co-initiator for the cationic curing of epoxy functional materials. Additionally, the tested epoxy resins also contain diglycidyl ether of bisphenol A (DGEBA) as a component monomer. This monomer is used in many epoxy formulations, where it provides both adhesive strength as well as improved corrosion resistance. It is not typically used in cationically cured systems since it is not very active to cationic polymerization, however, with the addition of TPED as a co-initiator in the cationic system, the DGEBA can be an active participant in the cationic thermal frontal polymerization. This cationic thermal FP initiation system was also shown to be robust and tolerant of large variation in the monomers used, assuming those monomers were cationically active and would release enough energy to allow the front to propagate.

The gel system also contains a multifunctional acrylate monomer or mixture of monomers capable of undergoing free radical polymerization with an additional radical initiator. By combining these polymerization methods, the radical for gelation and the cationic for the thermal FP, a resin is produced that can be gelled with either long-wave UV (UVA) or thermal energy, depending on the radical initiator chosen. FP can then be initiated using either heat or high intensity broad spectrum UV radiation. This resin was tested to determine its stability in both the gelled and liquid state. The rheological effects of varying the length of UV irradiation time to change the crosslink density of the acrylate portion of the resin was tested.

The gel cure time directly correlates to the crosslink density of the gel. Parallel plate rheology was used to determine the plateau modulus of the gels based on different cure times, and as the cure time increased, so did the plateau modulus. Equation 1 below is used to use known properties of the gel to calculate the molecular weight between crosslinks.

$${M}_{c} = \frac{1}{3} \frac{ρ RT {v}_{a}}{{G}_{m}}$$

Mc=Molecular weight between crosslinks
ρ=Density
R=Universal gas constant
T=Temperature in K
νₐ=Volume fraction of acrylate monomer
Gₘ=Plateau modulus
X_{c}=Crosslink density

Gₘ˜1/M_{c}˜X_{c} [1]

*Therefore Gₘ [symbol] ,X_{c}

[symbol]

Since Gm is inversely proportional to Mc, as the modulus increases with increasing cure time, the molecular weight between crosslinks decreases. As the molecular weight between crosslinks decreases this means there is a larger density of crosslinks leading to an increase in crosslink density. Therefore, as cure time increase, the plateau modulus increase, and as the plateau modulus increase, the crosslink density increases as well.

Bisphenol A glycerolate diacrylate, isobornyl acrylate (IA), tertbutyl methacrylate (TBMA), trimethylolpropane triacrylate, pentaerythritol triacrylate, tetrahydrofurfuryl acrylate, 3,4-epoxycyclohexylmethyl 3,4-epoxycyclohexanecarboxylate (ECC), epoxy functionalized, hydroxy terminated polybutadiene (Mn˜2600), poly(propylene glycol) diglycidyl ether (Mn˜380), 1,1,2,2-tetraphenyl-1,2-ethanediol, azobisisobutyronitrile (AIBN) and diphenyl(2,4,6-trimethylbenzoyl)phosphine oxide (TPO) were all purchased from MilliporeSigma. DGEBA (DER 332) was purchased from Olin Epoxy and p-(octyloxyphenyl) phenyliodonium hexafluoroantimonate was purchased from Gelest. All materials were used as supplied, without further purification.

The liquid and gel solutions were created by combining all components in an amber glass vial equipped with a stir bar. The vial was then capped and heated, with stirring, for 60 minutes at 60° C. and 600 rpm, in a heating well in the absence of light. The solution was then allowed to cool to room temperature in the dark. Any solution not immediately used, including any used for aging studies was stored in a glass container in the absence of light, with ambient air in the headspace. Samples for testing, depending on the radical initiator, were gelled with either UVA radiation or thermally and subsequently FP was initiated using the tip of a soldering iron at a controlled temperature or via UV irradiation using a Lumen Dynamics OmniCure S1500 UV source set at 50% intensity with a 250-450 nm filter at a distance of approximately 1 cm.

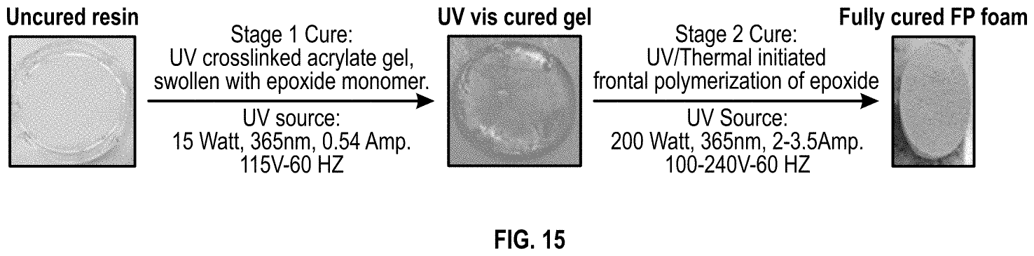

The gels are formed from an acrylate monomer, crosslinking agent and initiator being added into the formulation and in total consist of 5 wt % of the total formulation. In the optimal case the formulation consisted of the acrylate monomer tertbutyl methacrylate, crosslinking agent trimethylolpropane triacrylate and initiator: diphenyl(2,4,6 trimethylbenzoyl)phosphine oxide. The gel added another level of constraint on the system during the frontal polymerization process. This alters the cell shape and size, when compared to that of the liquid formulations. The gel also allowed for free standing specimens that can be manipulated in shape and size before frontal polymerization. The gelation and foaming process is shown in the FIG. 15.

The formulation for the gelled system and the liquid system differed only by the 5 wt % of the acrylate monomers added into the gel system. The gel formulation procedure had an additional step when compared to that of the liquid frontal foams. That additional step was the first stage curing of the 5 wt % acrylate monomers using ultraviolet-A (UVA) radiation. After the first stage of gel curing, the second stage frontal polymerization was initiated using the tip of a soldering iron at a controlled temperature or via UV irradiation using a Lumen Dynamics OmniCure S1500 UV source set at 50% intensity with a 250-450 nm filter at a distance of approximately 1 cm.

In contrast, the liquid formulations only underwent that second stage cure of only frontal polymerization using the tip of a soldering iron at a controlled temperature or via UV irradiation using a Lumen Dynamics OmniCure S1500 UV source set at 50% intensity with a 250-450 nm filter at a distance of approximately 1 cm.

Both systems were prepared in the same manner described earlier in the materials and methods. The only fabrication difference is that the gels undergo a first stage gelling cure, whereas the liquid formulations did not.

Foams manufactured from liquid formulations (including syntactic foams with hollow glass fillers) display a variety of advantageous properties. These are enumerated below.

In an embodiment, the foam has a density of 0.20 to 1.20 grams per cubic centimeter. In a preferred embodiment, the foam has a density of 0.35 to 0.6 grams per cubic centimeter. In a preferred embodiment, the syntactic foam with hollow glass filler has a density of 0.65 to 1.20 grams per cubic centimeter.

The foam has a compressive strength of 5 to 150 MPa. In a preferred embodiment, the foam has a compressive strength of 10 to 25 MPa. In a preferred embodiment, the syntactic foam with hollow glass filler has a compressive strength of 100 to 150 MPa. Foams with fillers have a compressive strength that is greater than those of a similar composition but without the fillers.

The foam has a compressive modulus of 0.2 to 3 GPa. In a preferred embodiment, the foam has a compressive modulus of 0.3 to 1 GPa. In a preferred embodiment, the syntactic foam with hollow glass filler has a compressive modulus of 2 to 3 GPa.

The foam has a specific compressive strength of 15 to 120 MPa. In a preferred embodiment, the foam has a specific compressive strength of 20 to 30 MPa. In a preferred embodiment, the syntactic foam with hollow glass filler has a specific compressive strength of 100 to 120 MPa.

The foam has a specific compressive modulus of 0.7 to 2.2 GPa. In a preferred embodiment, the foam has a specific compressive modulus of 0.8 to 1.2 GPa. In a preferred embodiment, the syntactic foam with hollow glass filler has a specific compressive modulus of 1.9 to 2.2 GPa.

The cells for foams manufactured from liquids have an average radius of 2 to 265 micrometers. The cells have an average aspect ratio of 1 to 3. These values are based on the cross section that is parallel to the propagating front. The aspect ratio is based on best fit ellipse calculated from major axis/minor axis therefore 1 is a circle, 5 means the major axis is 5 times that of the minor axis.

The properties of foams manufactured from gels is detailed below. The foam has a density of 0.6 to 1 grams per cubic centimeter. In a preferred embodiment, the foam has a density of 0.65 to 0.8 grams per cubic centimeter.

The gel (in unfoamed form) has a plateau modulus at a cure time of 10 minutes of 103 to 146 KPa. In a preferred embodiment, the foam has a specific compressive modulus of 114 to 146 KPa. The gel has a plateau modulus at a cure time of 20 minutes of 157 to 338 KPa. In a preferred embodiment, the foam has a specific compressive modulus of 303 to 338 KPa. The plateau modulus will increase with increasing gel cure time.

Foam cell size was measured parallel and perpendicular to the direction of the propagating front. For cells viewed parallel to the propagating front direction, the cells have an average radius of 3 to 51 micrometers. The cells have an average aspect ratio of 1.1 to 3.4. The aspect ratio is based on a best fit ellipse calculated from major axis/minor axis therefore 1 is a circle, 5 means the major axis is 5 times that of the minor axis.

For cells viewed perpendicular to the propagating front direction, the cells have an average radius of 5 to 118 micrometers. The cells have an average aspect ratio of 2.6 to 55.5. The aspect ratio is based on best fit ellipse calculated from major axis/minor axis therefore 1 is a circle, 5 means the major axis is 5 times that of the minor axis.

Applications of the above composition may include insulators, floatation devices, or packaging materials.

It is to be noted that all ranges detailed herein include the endpoints. Numerical values from different ranges are combinable.

The term “and/or” includes both “and” as well as “or.” For example, “A and/or B” is interpreted to include A, B, or A and B.

While the invention has been described with reference to some embodiments, it will be understood by those skilled in the art that various changes may be made, and equivalents may be substituted for elements thereof without departing from the scope of the invention. In addition, many modifications may be made to adapt a particular situation or material to the teachings of the invention without departing from essential scope thereof. Therefore, it is intended that the invention should not be limited to the particular embodiments disclosed as the best mode contemplated for carrying out this invention, but that the invention will include all embodiments falling within the scope of the appended claims.

What is claimed is:

1. A foam composition comprising:
a first epoxide comprising a first glycidyl epoxide and/or a first non-glycidyl epoxide;
a second epoxide comprising a second glycidyl epoxide and/or a second non-glycidyl epoxide;
wherein the first glycidyl epoxide is different from the second glycidyl epoxide and wherein the first non-glycidyl epoxide is different from the second non-glycidyl epoxide;
wherein the first and the second epoxide are cationically polymerizable;
an initiator; and
a diluent; wherein the diluent is present in about 0.1 to 30 wt %, based on the total weight of the composition, where the composition upon external stimulus undergoes an ionic polymerization reaction in a spatially propagating reaction front or in a global reaction that occurs throughout an entire composition.

2. The composition of claim 1, wherein the first glycidyl epoxide and the second glycidyl epoxide comprises glycidyl ethers based on phenols.

3. The composition of claim 2, wherein the phenol is resorcinol, bisphenol A, bisphenol F or mixtures thereof.

4. The composition of claim 1, where the first glycidyl epoxide and/or the second glycidyl epoxide glycidyl epoxide are present in a combined amount of 1 wt % to 50 wt %, based on the total weight of the composition.

5. The composition of claim 1, where the first non-glycidyl epoxide and the second non-glycidyl epoxide is bis(2,3-epoxycyclopentyl) ether, 1,2-bis(2,3-epoxycyclopentyloxy)ethane, 3,4-epoxycyclohexyl-methyl 3,4-epoxycyclohexanecarboxylate, 3,4-epoxy-6-methyl-cyclohexylmethyl 3,4-epoxy-6-methylcyclohexanecarboxylate, di(3,4-epoxycyclohexylmethyl)hexanedioate, di(3,4-epoxy-6-methylcyclohexylmethyl) hexanedioate, ethylenebis(3,4-epoxy cyclohexanecarboxylate, ethanediol di(3,4-epoxycyclohexylmethyl)ether, vinylcyclohexene dioxide, dicyclopentadiene diepoxide or 2-(3,4-epoxycyclohexyl-5,5-spiro-3,4-epoxy)cyclohexane-1,3-dioxane, or 2,2′-bis-(3,4-epoxy-cyclohexyl)-propane.

6. The composition of claim 1, where the first non-glycidyl epoxide and/or the second non-glycidyl epoxide is present in a combined amount of 40 wt % to 70 wt %, based on the total weight of the composition.

7. The composition of claim 1, where the first non-glycidyl epoxide or the second non-glycidyl epoxide non-glycidyl epoxide is 3,4-epoxycyclohexylmethyl-3′,4′-epoxycyclohexane carboxylate.

8. The composition of claim 1, where the initiator comprises a free radical initiator and an ionic initiator.

9. The composition of claim 1, wherein the initiator is present in an amount of 0.25 wt % to 2.5 wt %, based on the total weight of the composition.

10. The composition of claim 1, where the diluent comprises a polyol.

11. The composition of claim 1; where the hydroxyl number of the polyol is about 150-450 mg KOH/gram.

12. The composition of claim 1, wherein the composition further comprises nucleating agents.

13. The composition of claim 1, wherein the composition further comprises a filler.

14. The composition of claim 13, wherein the filler comprises fumed silica, glass beads or a combination thereof.

15. An article comprising the composition of claim 1.

16. The article of claim 15, comprising a porous article; wherein the density of the article is about 0.05 g/cm³ to 0.5 g/cm³.

17. A method of manufacturing a foam composition comprising:
mixing together a mixture prepared by a composition comprising:
a first epoxide comprising a first glycidyl epoxide and/or a first non-glycidyl epoxide;
a second epoxide comprising a second glycidyl epoxide and/or a second non-glycidyl epoxide;
wherein the first glycidyl epoxide is different from the second glycidyl epoxide and wherein the first non-glycidyl epoxide is different from the second non-glycidyl epoxide;
an initiator; and
a diluent; wherein the diluent is present in about 0.1 to 30 wt %, based on the total weight of the composition.

18. The method of claim 17, further comprising subjecting the mixture to an external stimulus; wherein the stimulus facilitates polymerization of the mixture.

19. The method of claim 17, wherein the mixing occurs in dark conditions.

20. The method of claim 17, where the temperature attained by the polymerized mixture is about 200° C. to 350° C.

21. The method of claim 18, wherein the mixture has a propagation rate of about 1 to 3 millimeters/second.

22. The method of claim 17, wherein the external stimulus comprises heat or UV radiation.

23. A foam composition comprising:
a free radical polymerizable composition; wherein the free radical polymerizable composition comprises a free radical polymerization initiator and a least one monomer having a functionality greater than 2; and
a cationically polymerizable composition comprising:
a first epoxide comprising a first glycidyl epoxide and/or a first non-glycidyl epoxide;
a second epoxide comprising a second glycidyl epoxide and/or a second non-glycidyl epoxide; wherein the first glycidyl epoxide is different from the second glycidyl epoxide and wherein the first non-glycidyl epoxide is different from the second non-glycidyl epoxide; wherein the first and the second epoxide are cationically polymerizable;
an initiator; and
a diluent; wherein the diluent is present in about 0.1 to 30 wt %, based on the total weight of the composition; and
wherein the free radical polymerizable composition is polymerized prior to the cationic polymerization and wherein the composition upon external stimulus undergoes a cationic polymerization reaction in a spatially propagating reaction front or in a global reaction that occurs throughout an entire composition.

24. A method of manufacturing a foam composition comprising:
mixing together a mixture comprising:
a free radical polymerizable composition; wherein the free radical polymerizable composition comprises a free radical polymerization initiator and a least one monomer having a functionality greater than 2; and
a cationically polymerizable composition comprising:
a first epoxide comprising a first glycidyl epoxide and/or a first non-glycidyl epoxide;
a second epoxide comprising a second glycidyl epoxide and/or a second non-glycidyl epoxide; wherein the first glycidyl epoxide is different from the second glycidyl epoxide and wherein the first non-glycidyl epoxide is different from the second non-glycidyl epoxide; wherein the first and the second epoxide are cationically polymerizable;
an initiator; and
a diluent; wherein the diluent is present in about 0.1 to 30 wt %, based on the total weight of the composition;
initiating polymerization of the free radical polymerizable composition; and
initiating polymerization of the cationically polymerizable composition.
